(19) United States
(12) Patent Application Publication
(10) Pub. No.: US 2006/0277167 A1
(43) Pub. Date: Dec. 7, 2006

(54) Search apparatus having a search result matrix display

(76) Inventors: William Gross, Pasadena, CA (US); Lee Hasiuk, Rochester, NY (US); Thomas McGovern, Pasadena, CA (US); Jason D. Levine, Los Angeles, CA (US)

Correspondence Address: CHRISTIE, PARKER & HALE, LLP, PO BOX 7068, PASADENA, CA, 91109-7068, US

(21) Appl. No.: 11/437,483

(22) Filed: May 19, 2006

Related U.S. Application Data
(60) Provisional application No. 60/684,253, filed on May 20, 2005.
(60) Provisional application No. 60/717,547, filed on Sep. 14, 2005.
(60) Provisional application No. 60/780,785, filed on Mar. 8, 2006.
(60) Provisional application No. 60/797,876, filed on May 5, 2006.

(51) Int. Cl. G06F 17/30

(52) U.S. Cl. 707/3

(57) ABSTRACT

A search apparatus with a user interface to a search engine is disclosed. The search apparatus includes a search term field, a search result list area and a search result display area. The search term field is adapted to receive a search term to be submitted to a search engine to initiate a search. The search result list area is used to display a list of search results found during the search. The search result display area is adapted to display one or more web pages corresponding to the search results, wherein the web pages are displayed in a matrix format. When configured to display two or more web pages, the at least two web pages are concurrently displayed. The number of the web pages concurrently displayed in the search result display area is user selectable.

### CROSS-REFERENCE TO RELATED APPLICATION(S)

This application claims priority to and the benefit of U.S. provisional patent application No. 60/684,253 entitled “Search Apparatus Having a Search Result Matrix Display,” filed on May 20, 2005; U.S. provisional patent application No. 60/717,547 entitled “Search Apparatus Having a Search Result Selection with Matrix Display,” filed on Sep. 14, 2005; U.S. provisional patent application No. 60/780,785 entitled “Improved Search Engine with Keyword Suggestion Tool,” filed on Mar. 8, 2006; and U.S. provisional patent application no. ______ (Attorney Docket No. PM.003P) entitled “A Search Apparatus Having a Search Result Matrix Display and Content Centering,” filed on May 5, 2006, the entire contents of all of which are incorporated herein by reference.

### FIELD OF THE INVENTION

This invention relates to web browsers and search engines, and more particularly, to a search apparatus capable of displaying search results and corresponding web pages side-by-side, and optionally displaying multiple web pages corresponding to the search results in a matrix format.

### BACKGROUND

Internet toolbar search apparatuses and similar apparatuses and search methods are typically used to search for information on-line by submitting queries with search terms or keywords. The results of the search are typically returned in a form of a search result page.

Therefore, in a conventional search apparatus, when a user enters a search term and hits ‘Enter’, the user is taken away from the page/site that he is currently viewing and brought to the search result page associated with the search apparatus or search engine. By way of example, the search result page typically lists the names of the web sites found and/or their URLs, which typically are hypertext linked to the respective web sites.

In order to actually access the web sites, the user typically selects one or more of the web sites or URLs, for example, by clicking the name of the desired web site with a mouse. This action typically results in displaying a content of only one web site at a time. It may be desirable, however, to sometimes view and compare the contents of several web sites at the same time. Therefore, it is desirable to provide an apparatus and method which enable the user to view contents of multiple web sites at the same time.

Further, under the current search engine paradigm, a great deal of user interaction, attention and decision making are required during a search process that takes place between user's identification of information needs and satisfaction of the identified information needs.

The search process may broadly be classified into three operations, namely, entry, process and exit operations. During the entry operation, the user 1) navigates to the search engine, 2) lands at search engine splash page, 3) locates query entry box, 4) enters query, and 5) invokes search. All these tasks are typically performed by the user. During the process operation, the system loads the search results. Then the user 1) scans the loaded search results, 2) evaluates the search results based on brief textual descriptions of the results, 3) chooses or selects one or more of the search results, and 4) clicks the selected search result before having an opportunity to view the web page associated with the selected search result. Finally during the exit operation, the system loads the destination page corresponding to the user's selection and mouse click. Then the user scans and evaluates the destination page.

The search process can be made more convenient to the user if one or more tasks in the process and/or exit operations can be automated or optionally automated, or combined into a single operation.

### SUMMARY OF THE INVENTION

An aspect of the present invention is to provide an apparatus and method which enable a user to view contents of multiple web sites corresponding to search results at the same time, while concurrently viewing a list of the search results.

Another aspect of the present invention is to provide an apparatus and method which enable and/or optionally enable automation and/or combination of one or more search tasks and/or exit operations.

In an exemplary embodiment according to the present invention, a search apparatus includes: a search term field adapted to receive a search term to be submitted to a search engine to initiate a search; a search result list area for displaying a list of search results identified by the search engine; and a search result display area for displaying one or more web pages corresponding to the search results. The web pages are displayed in a matrix format when at least two of the web pages are concurrently displayed, and the number of the web pages concurrently displayed in the search result display area is user selectable.

In another exemplary embodiment according to the present invention, a search apparatus including a web browser and a plug-in adapted to be implemented into the web browser is provided. The search apparatus includes: a search term field adapted to receive a search term to be submitted to a search engine to initiate a search; a search result list area for displaying a list of search results found during the search; and a search result display area for displaying one or more web pages corresponding to the search results. The web pages are displayed in a matrix format when at least two of the web pages are concurrently displayed, and the number of the web pages concurrently displayed in the search result display area is user selectable.

In yet another exemplary embodiment according to the present invention, a method of displaying a list of search results concurrently with one or more web pages corresponding to the search results, is provided. The method includes: submitting a search term to a search engine to initiate a search; displaying the list of search results in a first area of a display screen; and displaying said one or more web pages corresponding to the search results in a second area of the display screen. The web pages are displayed in a matrix format when at least two of the web pages are concurrently displayed, and a number of the web pages concurrently displayed in the second area is user selectable.

These and other aspects of the invention will be more readily comprehended in view of the discussion herein and accompanying drawings.

### BRIEF DESCRIPTION OF THE DRAWINGS

FIG. 1 is a screen shot of a search apparatus depicting a matrix of four web pages (e.g., web site contents) in a search result display area, in accordance with an exemplary embodiment of the present invention.

FIG. 2 is a screen shot of the search apparatus of FIG. 1, wherein four different web pages are displayed in the search result display area.

FIG. 3 is a screen shot of the search apparatus of FIG. 1, wherein only one of the web pages has been replaced with another web page, as compared to the screen shot of FIG. 1.

FIG. 4 is a screen shot of the search apparatus of FIG. 2, which illustrates a pull down area (or menu) that can be used to select the size of the matrix of the search result display area.

FIG. 5 is a screen shot of the search apparatus of FIG. 2, which includes a 3×2 matrix of the web pages corresponding to the search results.

FIG. 6 is a screen shot of the search apparatus with a preference window displayed.

FIG. 7 is a screen shot of the search apparatus showing a user interface utilizing search grid size selection buttons.

FIG. 8 is a flow diagram illustrating a process of downloading and displaying web pages corresponding to search results in accordance with an exemplary embodiment of the present invention.

FIG. 9A is a functional block diagram showing an implementation of a search apparatus as a plug-in into a web browser according to one exemplary embodiment of the present invention.

FIG. 9B is a functional block diagram showing an implementation of a search apparatus as a plug-in into a web browser in accordance with another exemplary embodiment of the present invention.

FIG. 10 is a schematic screen view showing one highlighted search result listing and associated result preview (i.e., web page) in accordance with one exemplary embodiment of to the present invention.

FIG. 11 is a schematic screen view showing one highlighted search result listing and associated result preview with highlight search terms in accordance with another exemplary embodiment of the present invention.

FIG. 12 is a schematic screen view showing four highlighted search result listings and associated preview panes in accordance with one exemplary embodiment of the present invention.

FIG. 13 is a schematic screen view showing four non-sequential highlighted search result listings and associated previous panes in accordance with another exemplary embodiment according of the present invention.

FIGS. 14A and 14B are schematic screen views that illustrate selection/highlighting of sequential search result listings and associated result preview panes in accordance with one exemplary embodiment of the present invention.

FIG. 15 illustrates opening of a web page in one of the preview panes in a new window in accordance with one exemplary embodiment of the present invention.

FIG. 16 illustrates navigational functionalities of a preview pane in accordance with one exemplary embodiment of the present invention.

FIGS. 17A to 17D illustrate another exemplary embodiment of the present invention where text is reduced a different amount than the graphics when viewing a “thumbnail” type display of a web page.

FIG. 18 is a system block diagram of a search apparatus coupled to a computer network in accordance with one exemplary embodiment of the present invention.

FIG. 19 is a schematic screen view that illustrates search result listings and a web page corresponding to one of the search results in accordance with one exemplary embodiment of the present invention.

FIG. 20 illustrates steps of content centering in accordance with one exemplary embodiment of the present invention.

### DETAILED DESCRIPTION

In exemplary embodiments according to the present invention, a search apparatus includes a search result display area (e.g., window or pane) that can be used to display one or more selected search results in a matrix format.

In one embodiment, a search apparatus includes a search term field, a search result list area and a search result display area (or search result exhibit area). A user enters at least one keyword or search term in the search term field and submits the query to a search engine (e.g., via the Internet). A list of search results is provided in the search result list area. Contents (e.g., web pages) of one or more web sites corresponding to the search results are displayed in a single window or in a matrix format in the search result display area. In one embodiment, a user can select the number of rows and columns of the search results displayed in the matrix format in the search result display area. The names of the web sites whose content is displayed in the search result display area may be highlighted in the search result list area.

In one embodiment, contents of the web sites are displayed in the search result display area in corresponding windows or frames referred to herein as preview panes or sub-areas. These preview panes are used to display one or more selected search results from the search result display area. The content associated with both the currently selected search results and some unselected search results may be pre-loaded. The content of web sites that are listed in the search result list area but not displayed in one of the preview panes may be pre-loaded before or after the currently displayed web sites. The content of the web sites in the preview panes may be stored in local memory until the content of the preview panes are updated.

The windows (or preview panes) containing the displayed web sites may be re-arranged in the search result display area such that the windows need not be loaded again each time the web pages displayed in the search result display area are changed or updated. The maximum number of windows used for pre-loading and the maximum number of windows that are downloaded concurrently are user selectable in one embodiment.

The user may be able to select and/or limit the types of web site contents that can be displayed in the windows of the search apparatus. The search apparatus may be a stand-alone application or may be integrated with a web browser or other suitable application (e.g., as a plug-in). The search apparatus may be capable of defining a bookmark that includes multiple search results. The user may combine two or more search results to create one overall bookmark corresponding to the search results. The search apparatus in one embodiment can display a list of links found in a particular web site on one side of the screen, together with their respective contents on the other side of the screen.

Hence, using exemplary embodiments of the present invention, it is possible to selectively preview content of a single web site corresponding to a search result or concurrently preview contents of multiple web sites corresponding to two or more search results, while at the same time, viewing a list of the search results. The contents of the multiple web sites corresponding to the search results can be displayed in a matrix format, and the size of the matrix (i.e., the number of rows and columns) can be user selectable.

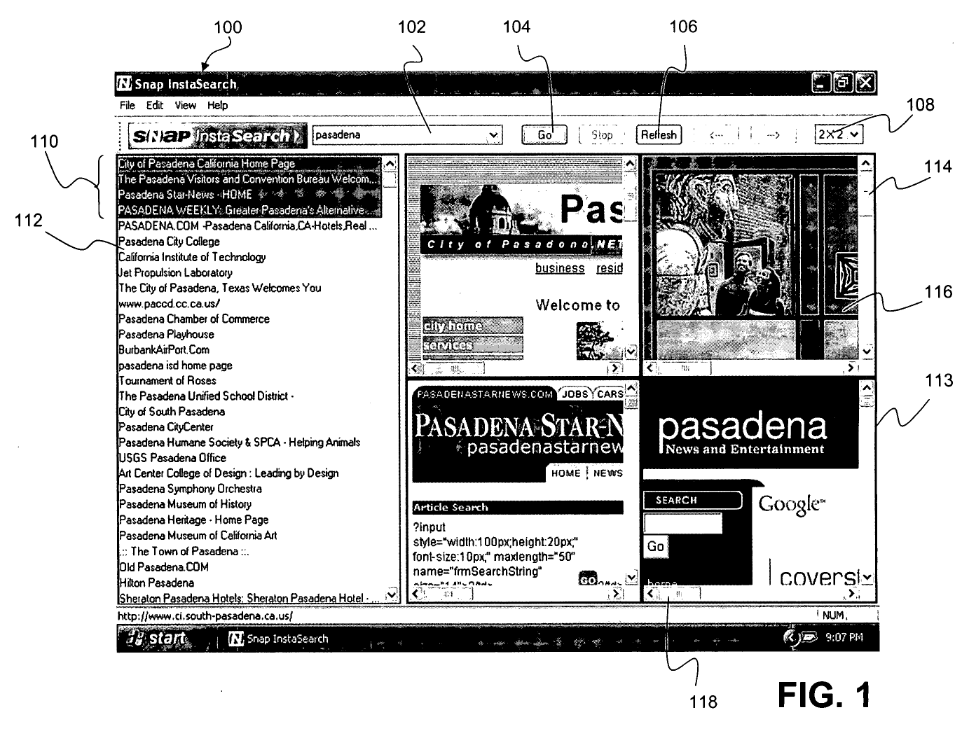

FIG. 1 is a screen shot of the user interface of a search apparatus in accordance with an exemplary embodiment. The user interface of the search apparatus includes a main window 100 with a search term field (i.e., a keyword field) 102, a search result list area 112 and a search result display area 113. The respective areas of the main window 100 occupied by the search result list area 112 and the search result display area 113 may be adjusted. The relative positions of the search result list area and the search result display area may also be adjusted in one of a plurality of horizontal-distributed or vertical-distributed patterns. By way of example, a search result list area may be displayed on the right side of the window 100, i.e., screen, while a search result display area is displayed on the left side of the screen.

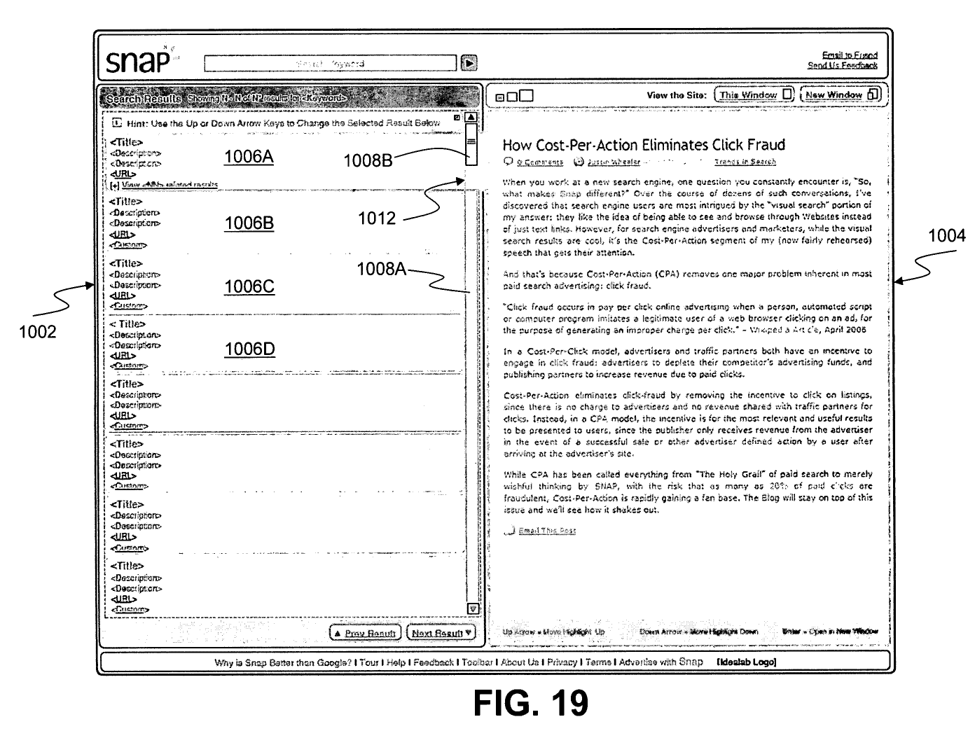

In addition to search results found during an Internet search, the list of search results in the search result list area (or the result pane) 113 could include those from an index of a provider of the search apparatus, from an index of the provider's strategic partner, from a user's index, from the user's hard drive, from an Really Simple Syndication (RSS) feed, etc. In addition, the list of search results could include result types such as images, video, news, job listings, personals, classifieds, and combinations thereof. As such, the search apparatus could rank all the result types together and display result types from multiple, distinct databases. This “commingled results” feature in one embodiment according to the present invention will be further described below in reference to FIG. 19. The list of search results may also include local hard drive content(s), enterprise search data, email(s), spreadsheet data, personal database(s), file system(s), etc.

The search result list area 113 can be populated in a standard search engine manner by displaying a static set of 10, 20 or more results. Alternatively, the search result list area 113 may be populated dynamically such that the bottom of the list of results does not appear. As the user progresses down the list of results they hit, the search apparatus encounters trigger points that invoke calls to the server through Ajax (or other appropriate method) to bring in the next set of results without ever reloading the page. This allows the user to observe a continuous stream of results instead of multiple, static pages. This way, the user can view a single continuous list of search results regardless of the number of search results found during a search. This “bottomless results” feature in one embodiment according to the present invention will be further described below in reference to FIG. 19.

Returning now to FIG. 1, a search term “pasadena” has been entered in the search term field 102, and a ‘go’ button 104 has been pressed to submit a query to the associated search engine. Names of the web sites (e.g., search results) are returned and displayed in the search result list area 112. The contents of the first four web sites listed in the search result list area 112 are displayed in the search result display area 113. It can be seen in the search result list area 112 that the top four web sites 110 have been highlighted in accordance with the number of web sites displayed in the search result display area 113. The number (i.e., four) of web sites displayed in the search result display area 113 corresponds to the size of the matrix shown in a matrix configuration field 108 of the search apparatus.

Each preview pane 116 of the search result display area 113 displays a type of content (e.g., web page or other resource) of one of the search results (e.g., web site) listed. The preview pane in the preferred embodiment includes a vertical scroll bar 114 and a horizontal scroll bar 118 such that the web site content displayed therein can be scrolled vertically and/or horizontally. In addition, one or more of the preview panes 116 can be refreshed by pressing a refresh button 106. Each of the preview panes 116 can be written as a stand alone application, which may be referred to as a pane, a preview pane, a window, a sub-window, a preview window, or the like.

Alternatively, each preview panes 116 may be implemented using any suitable generally available application or method known to those skilled in the art. By way of example, in one exemplary embodiment, each of the preview panes 116 may be implemented as a web browser, and may be implemented based on Microsoft® web browser ActiveX control technology, Mozilla Firefox® extensions, Macromedia Flash® JavaScript®, Ajax, java, and/or other suitable technologies. The preview panes 116 may alternatively be implemented using any other suitable web browser control or other technology known to those skilled in the art. Microsoft® is a registered trademark of Microsoft Corporation, Redmond, Wash. Firefox® is a registered trademark of Mozilla Foundation, Mountain View, Calif. Macromedia and Macromedia Flash are registered trademarks of Macromedia, Inc., San Francisco, Calif. JavaScript® is a registered trademark of Sun Microsystems, Inc., Palo Alto, Calif.

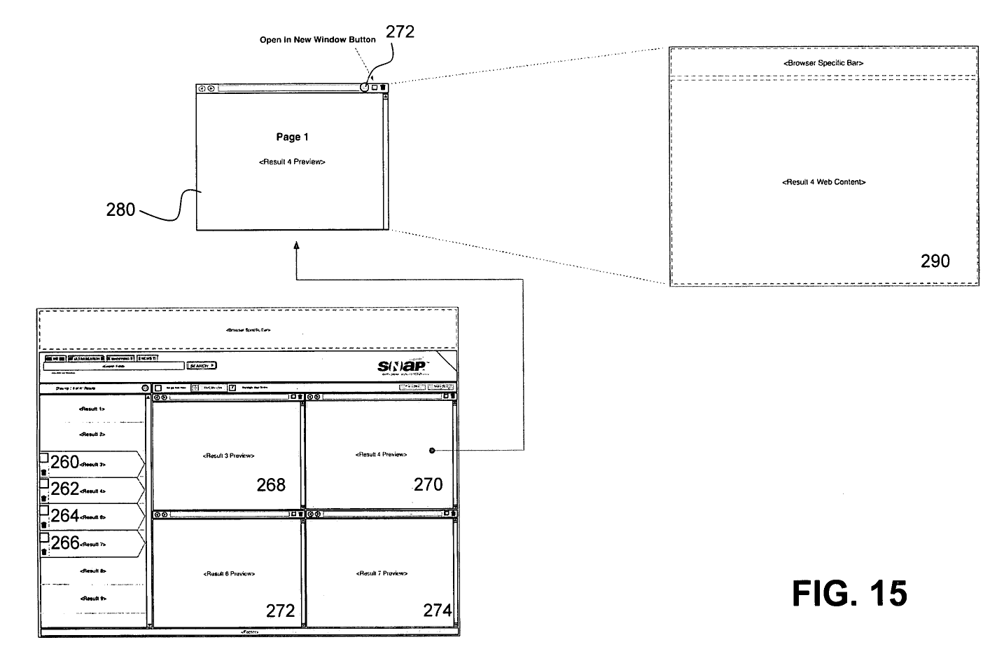

When one of the preview panes 116 (or content therein) is selected through a mouse click, for example, the content of the selected preview pane may be redisplayed in full scale in a newly opened web browser window (see FIG. 15, for example). This way, an enlarged view of the desired web content in one of the windows can be displayed. Alternatively, a user may zoom in on one or more of the preview panes 116. For example, in exemplary embodiments of the present invention, the user may select (or click on) one of the borders of a desired window, and drag it across the screen to enlarge that window or otherwise enlarge the desired window using any other suitable zoom function built into the search apparatus. The search result display area 113 may be enlarged together with one or more preview panes to view an even larger preview pane or window 116. The user may also be able to switch back and forth between the matrix display and an enlarged view of one or more of the preview panes in the search result display area 113.

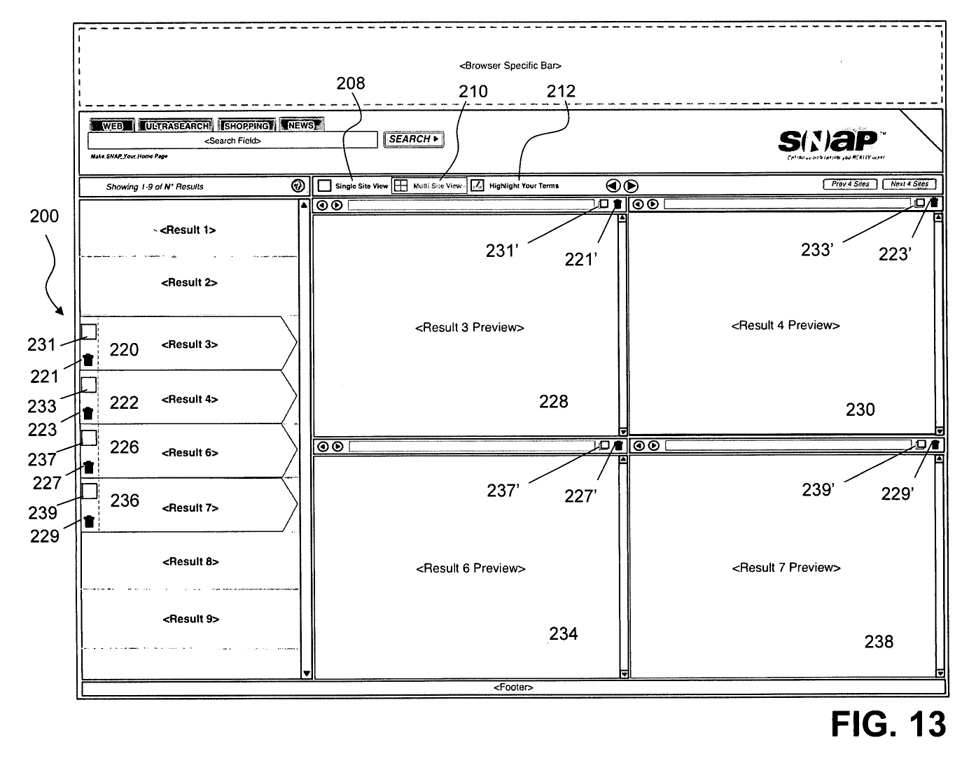

Each preview pane 116 may include a uniform resource locator (URL) field allowing a user to enter and edit a URL therein. Each preview pane 116 may also include history buttons allowing a user to navigate backward and forward through different web pages stored in history of the respective preview panes or windows. Each preview pane 116 may also include a button configured to open a web page currently in the preview pane in a new window. These features can be seen in FIGS. 12-16, for example.

Each preview pane 116 may be configured to display various types of content including, but not limited to, live destination HTML(s), proxied destination HTML(s), flash destination rendering(s), java destination rendering(s), destination site screen capture(s), live destination image rendering(s), RSS feed(s), text abstract(s), PDF(s), Microsoft Office document(s), editorial content(s), third-party content(s), etc.

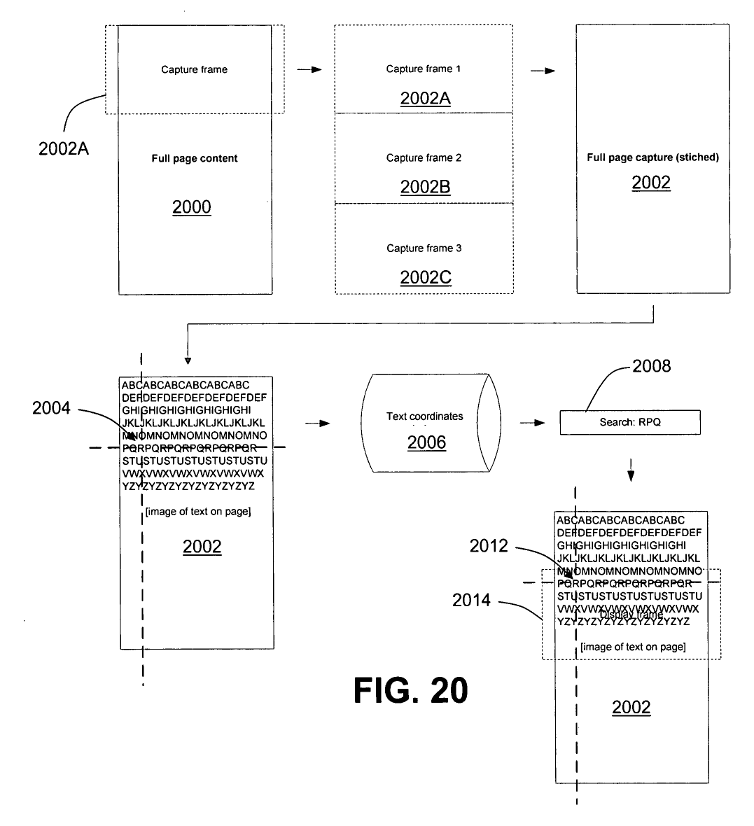

Each preview pane 116 may also exhibit functionality whereby the destination content of interest to the user, either text or image, is centered in view or preview presented to the user in response to a query. In one embodiment, such centering takes places as a two part process. The first part of the process is the creation of full scroll screen captures, during which a server crawls a distinct URL and captures not just the visible screen, but the below-the-fold area as well. The second part of the process is an indexing of the captured images. This renders a relational table that maps the occurrence of all text strings on the page to a pixel location. When the user subsequently performs a search, a lookup is performed using a search engine to find the pixel location of the user's search term and the portion of the associated web page selected accordingly. This way, the relevant image content is displayed as centered and/or otherwise highlighted. This “content centering” feature in one exemplary embodiment according to the present invention is further described below in reference to FIG. 20.

In one embodiment, the search apparatus in its simplest form displays only one preview pane in the search result display area 113, which displays an html document (e.g., a web page) corresponding to one of the search results listed in the search result list area 112. Such web page may be displayed in a web browser in the preview pane. When only one preview pane is displayed in the search result display area 113, the matrix configuration field 108 may display “1×1” to indicate that there is only one preview pane being displayed.

One of the features of the search apparatus in one embodiment is that the windows that make up the preview panes 116 are pre-loaded with the content (e.g., web pages) of the selected web sites from the search results. The number of pre-loaded web pages may exceed the number of the preview panes that are displayed at any given point in time. By way of example, the contents of 25 web sites may be respectively pre-loaded into local memory even though only four preview panes 116 are concurrently visible or displayed in the search result display area 113 at a time. This way, when the web sites that are listed adjacent or close to the web sites being displayed in the search result display area 113 are selected for display in the search result display area 113, the delay in displaying the contents of the newly selected web sites is reduced or minimized.

To reduce or minimize the delay experienced by a user when the user chooses to view the contents of the web sites listed in the search result list area 112 that are before or after the currently displayed web sites, the windows that make up the preview panes 116 (including the displayed windows and non-displayed windows, i.e., windows that are outside the search result display area 113 but accessible by scrolling, for example) are pre-loaded with the web sites that appear in the list both before and after the web sites being displayed. By way of example, if the search result display area 113 displays contents of four web sites, and 24 web sites have been pre-loaded, the pre-loaded web sites include the four web sites being displayed as well as 10 web sites that appear in the list of search results immediately before the four currently displayed web sites and 10 web sites that appear in the list of search results immediately after those four currently displayed web sites.

The pre-loaded windows may be dynamically updated (e.g., constantly adjusted) such that they contain the same number of web sites that are before and after the web sites being displayed. The number of pre-loaded web pages associated with search results listed before and after the displayed search results may not be equal under all circumstances. For example, when the four displayed web sites are at or near the beginning of the list of search results in the search result list area 112 (as shown in FIG. 1) or at or near the end of the list of search results in the search result list area 112, none or a lesser number of the web sites before or after, respectively, of the displayed web sites may be pre-loaded into the windows simply because of unavailability of the required number of web sites in the search result list before or after the displayed web sites. Instead, more web sites after the displayed web sites or before the displayed web sites may respectively be pre-loaded into the windows that are not visible (or displayed) on the search result display area 113.

To reduce or minimize the delay in displaying contents of the web sites that a user selects for display, the contents of the windows that make up the preview panes 116 may be stored in local memory (e.g., memory other than that corresponding to the preview panes) prior to those preview panes being updated. This way, contents of the previously viewed web sites may be available in local memory for viewing with little or no time delay instead of having to download the contents into the windows over the Internet again.

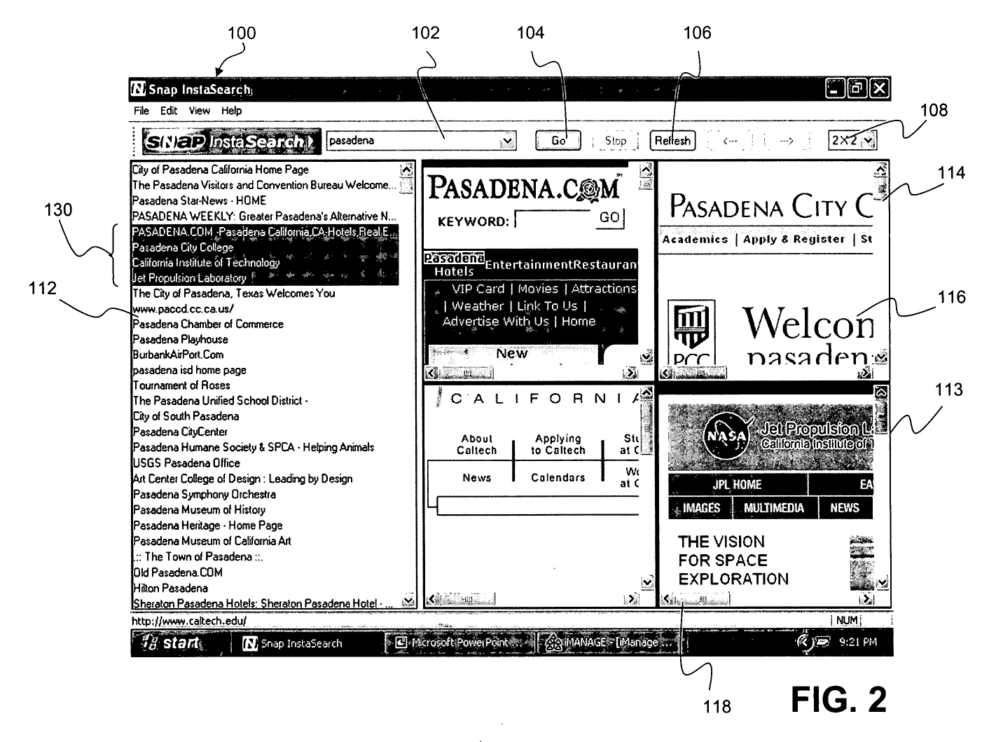

FIG. 2 is another screen shot of the user interface of the search apparatus of FIG. 1, which illustrates that contents of the next four web sites in the list of search results are displayed in the search result display area 113. Also, it can be seen in the search result list area 112 that the next four names 130 of the web sites in the list of search results are highlighted.

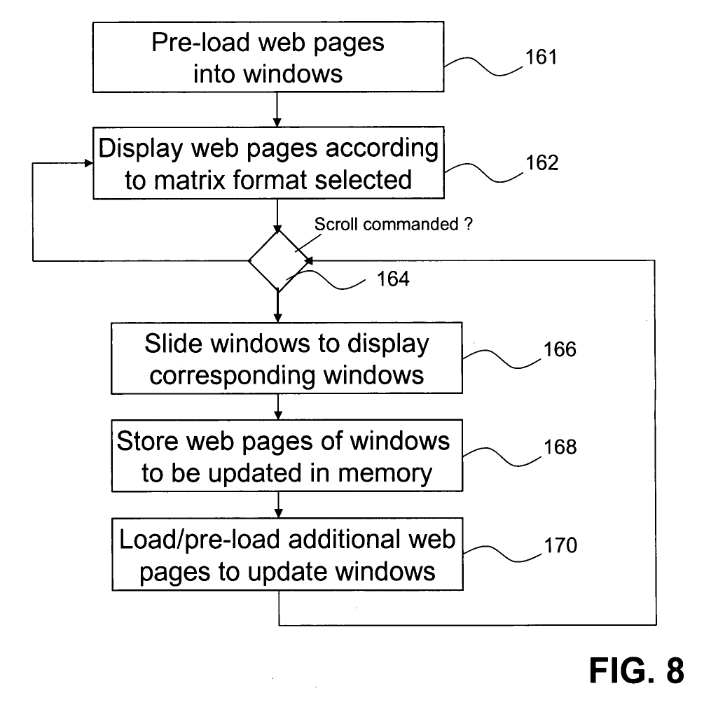

In this case, the windows corresponding to the preview panes 116 may not be re-loaded to reflect the changes. Instead, the location of the windows in the search result display area may be changed (e.g., the web sites are slid into new slots) to update the displayed web sites. By way of example, the windows including the first four web sites may be slid out of the view, while the next four web sites may be slid into the view as can be seen by comparing FIGS. 1 and 2. This feature of the present invention may be referred to as a “sliding window” feature, which is further illustrated in FIG. 8 below.

The web pages displayed in the search result display area 113 are linked to the search results selected in the search result list area 112. The web pages corresponding to the search results to be displayed in the search result display area 113 can be selected and/or updated by scrolling down the search result list area 112 using arrow keys and/or by selecting the first search result to be displayed using a mouse, for example. Also, while the first four web sites (i.e., contents thereof or web pages) in the list of search results are displayed in FIG. 1 and the next four web sites (i.e., contents thereof or web pages) are displayed in FIG. 2, it is possible to start the display of the contents (or web pages) starting at any of the web sites found during the search and listed in the search result list area 112.

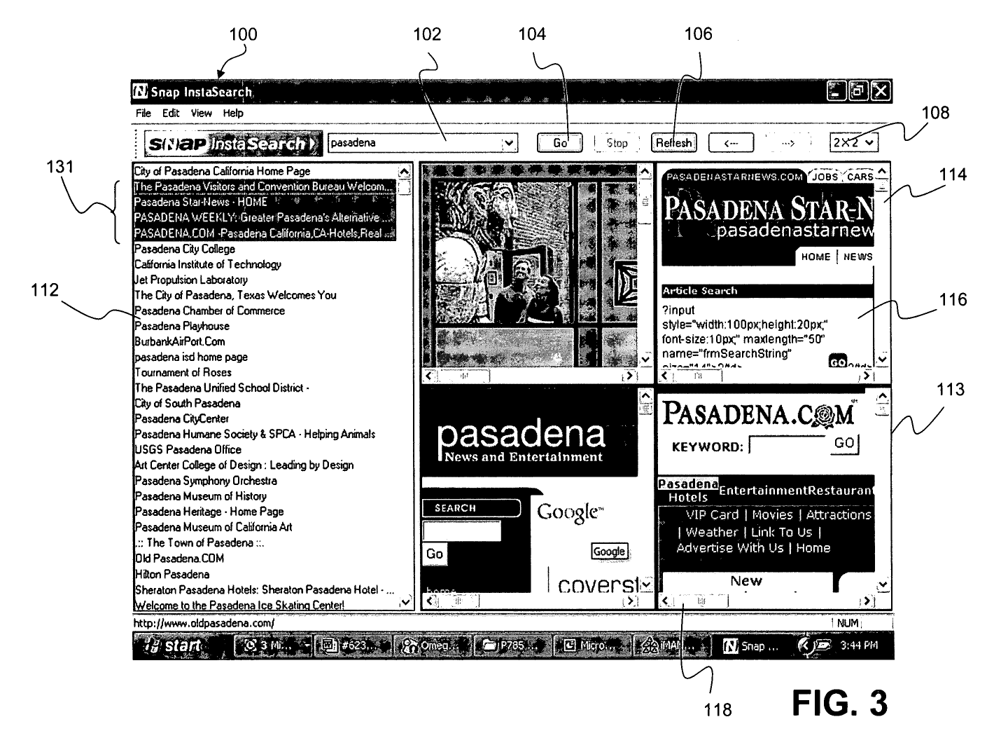

By way of example, instead of updating the web pages that are being displayed in groups of four, as done in the case of FIG. 2, the web pages being displayed may be updated one by one (with respect to the display of FIG. 1) as shown in FIG. 3. As can be seen in FIG. 3, the highlighted names of web sites 131 in the search result list area 112 have changed (advanced down the list) by just one, and correspondingly, the web pages being displayed in the search result display area 113 have changed by one only. Scrolling in the search result list area 112 one at a time may, for example, be achieved through mouse-clicking the next web site from the list of search results. The user may also be able to scroll the search results in the search result list area 112 by one using a combination of ‘Ctrl’ and down/up arrow, for example.

In this case, similar to the case of FIG. 2, the windows or frames corresponding to the preview panes 116 may not be re-loaded to reflect the change. Instead, the location of the windows in the search result display area may be changed (e.g., slid into new slots) to update the web pages that are being displayed. In the process, as can be seen by comparing FIGS. 1 and 3, the window for “City of Pasadena Calif. Home Page” becomes an invisible window, and the other three windows are re-arranged, while the window containing “PASADENA.COM . . . ” is newly added as the last web page to be displayed. As described in reference to FIG. 2 above, such re-arrangement of the windows according to exemplary embodiments of the present invention may be referred to as a “sliding window” feature.

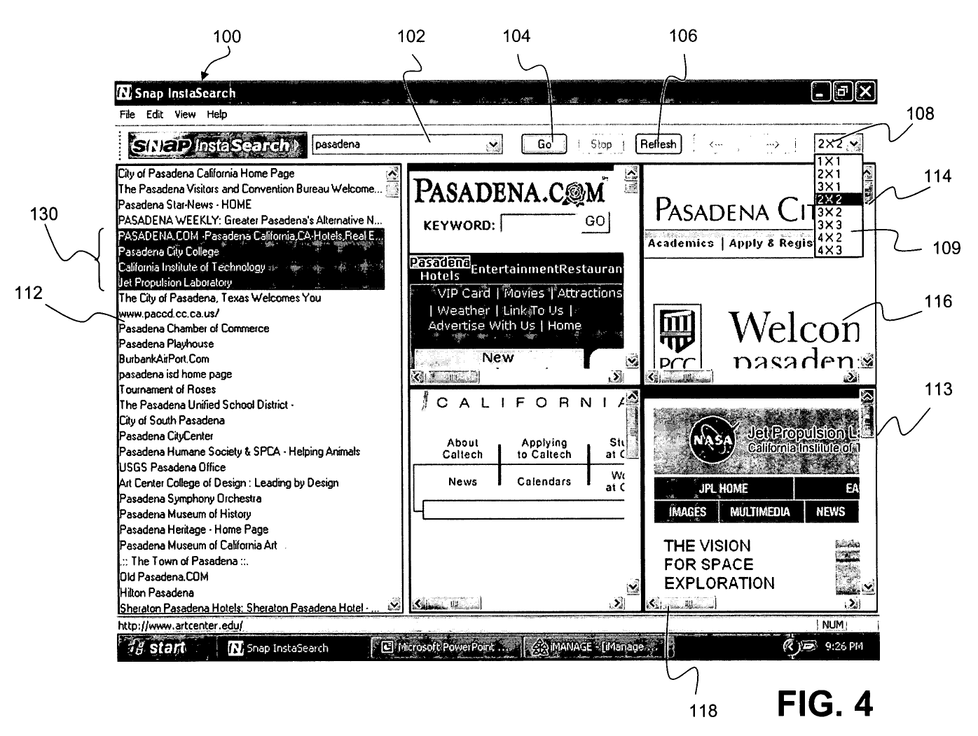

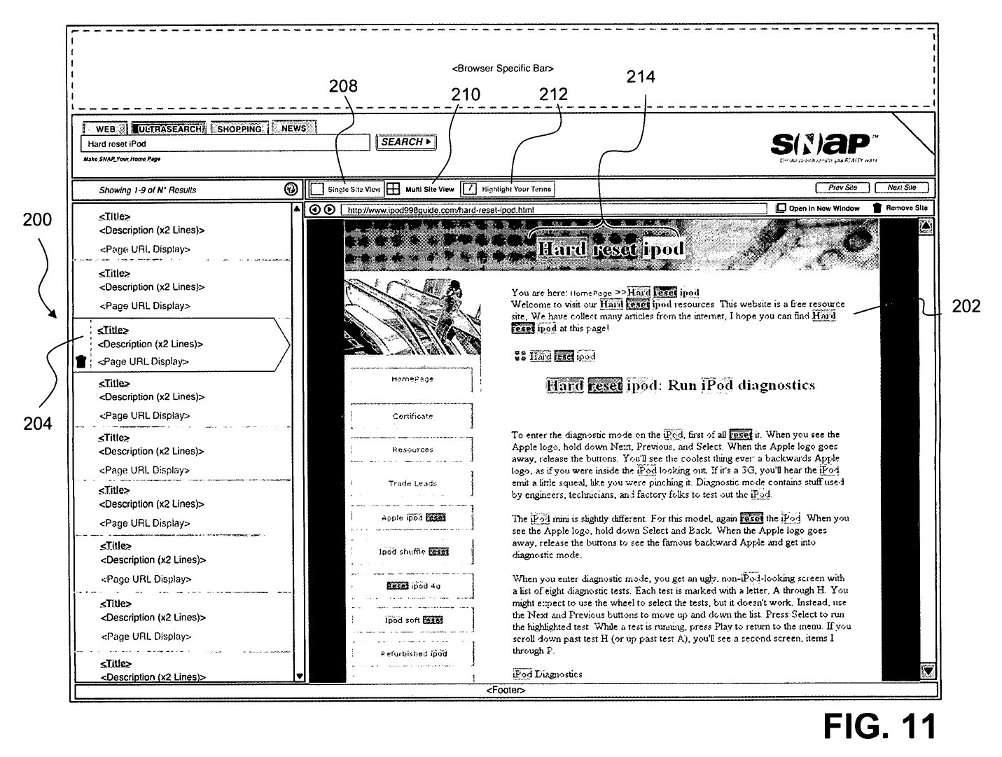

The size of the matrix of the search result display area 113 can be adjusted using the matrix configuration field 108. The matrix configuration field 108 allows the user to select from one of a plurality of predefined matrix configurations, each configuration having a specific number of preview pane columns and rows in the search result display area 113. By way of example, as can be seen in FIG. 4, by clicking the down arrow symbol next to the matrix configuration field 108, a size selection area (or menu) 109 can be pulled down. It can be seen that the size of the matrix can be any of 1×1, 2×1, 3×1, 2×2, 3×2, 3×3, 4×2 and 4×3 in the described embodiment. In other embodiments, other matrix formats may be provided. In still other embodiments, the search apparatus may provide buttons for switching back and forth between displaying single and multiple preview panes or windows in the search result display area 113 (see FIG. 10, for example).

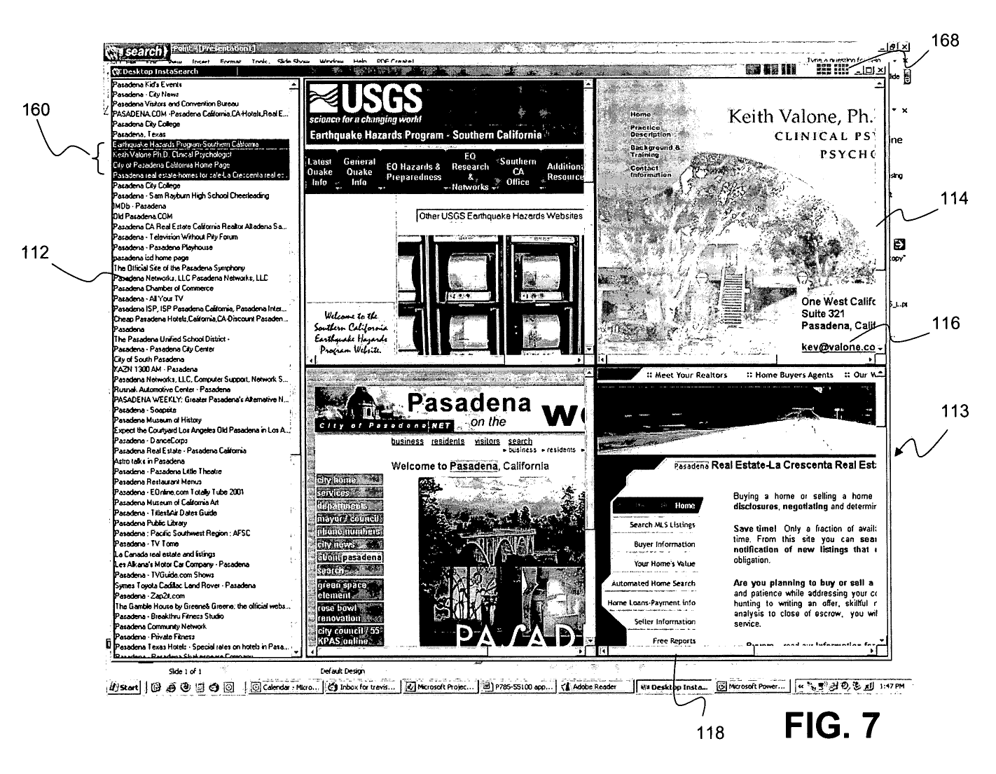

In other embodiments, the size of the matrix may be adjusted using search grid size selection buttons. As can be seen in FIG. 7, a number of search grid size selection buttons 168 are provided to adjust the size of the matrix. As shown in FIG. 7, each of the six buttons 168 includes grid lines that represent the size of the matrix, for example, 1×1, 2×1, 3×1, 4×4 (which is selected in FIG. 7), 3×3, 4×3. These and/or other buttons illustrating other matrix sizes may be provided in other embodiments. Further, matrix sizes may be represented using alphanumeric characters and/or other symbols rather than using grid lines in other embodiments. As in other screen shots, the names of the web sites 160 being displayed on the search result display area 113 are highlighted in the search result list area 112.

In other embodiments, the size of the matrix may be adjusted using a slider feature. By way of example, a slider may be used to change the size of matrix between different matrix sizes. In addition, a slider may be used to zoom in and out of the search result display area 113 and/or one or more of the preview panes 116. Further, a slider may be used to scroll through the search result display area 113 such that hidden windows (preview panes not yet displayed) may be displayed instead of the normally displayed windows as the search result display area 113 is scrolled. While the contents of the web sites displayed in the search result display area 113 are being changed, different ones of the web site names in the search result list area 112 may be highlighted to correspond to the displayed contents.

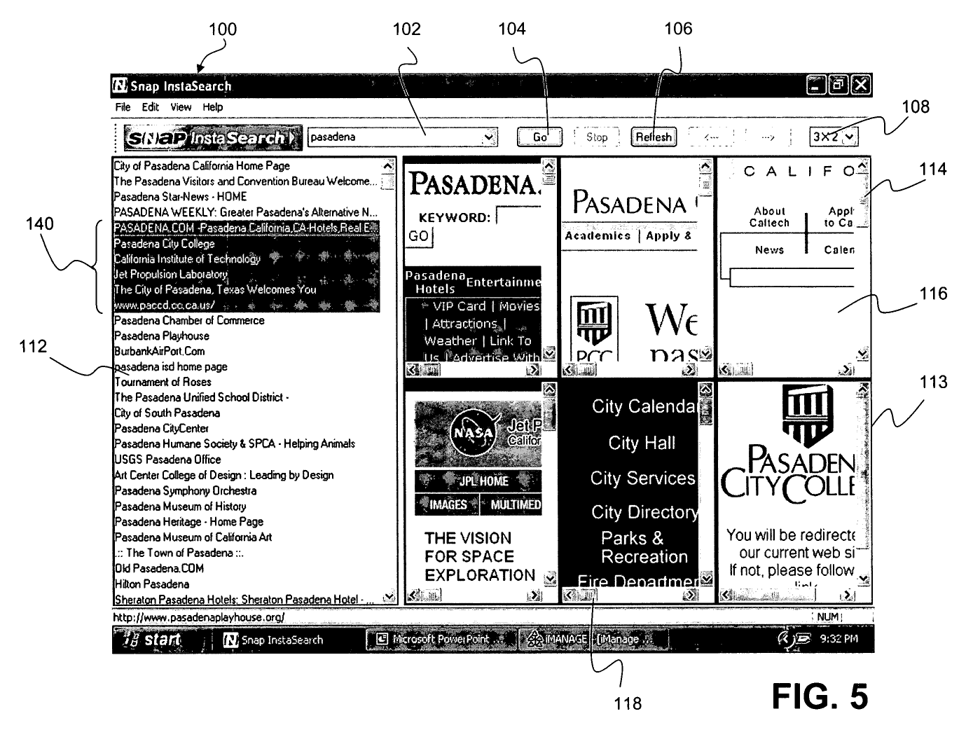

As can be seen in FIG. 5, the contents of six web sites found during the search are displayed in the search result area 113 when the size of the matrix selected is 3×2 as can be seen in the matrix configuration field 108. Also, it can be seen in the search result list area 112, that the names (URL or other resource identifier) of six web sites 140 are highlighted to correspond to the web sites displayed in the search result display area 113. When selecting the size of the display matrix using any of the above-described embodiments, or other alternate embodiments, the highlighted search names of the displayed web sites are updated at the same time as the display grid size changes, so that the highlighting in the search result list area 112 always reflects the web sites that are displayed in the search result display area 113.

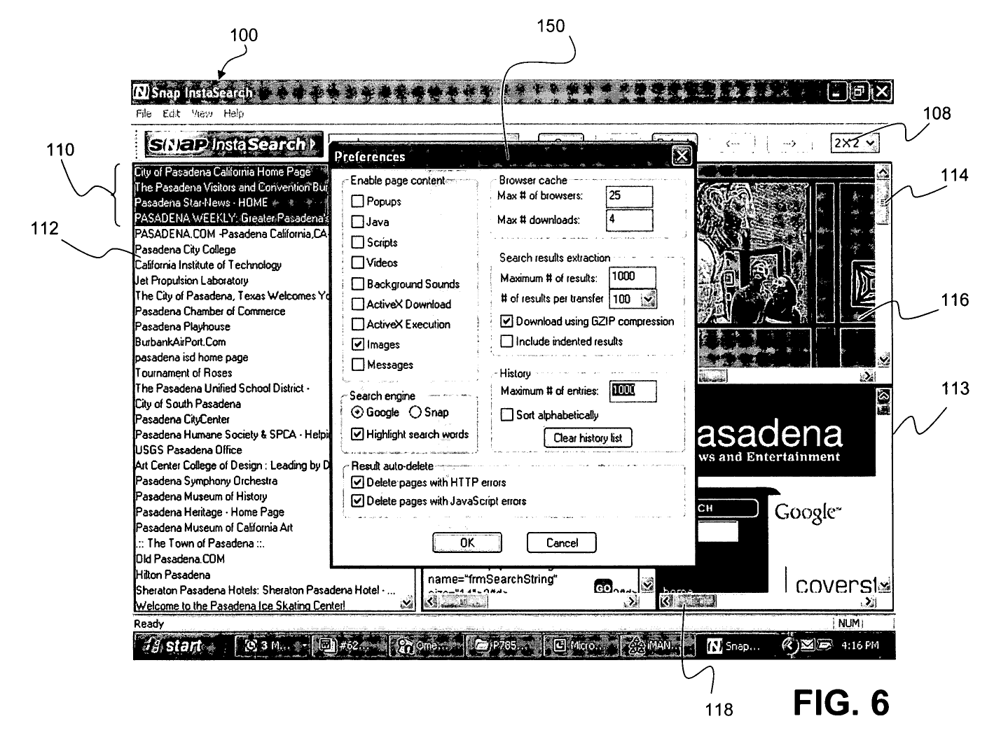

It can be seen in FIG. 6 that a number of parameters for the search apparatus can be selected or modified using a preference window 150 that displays a menu of preferences. By way of example, a user can select the maximum number of windows that are used for pre-loading web sites using a window cache feature (e.g., Browser cache feature). For example, the maximum number of windows for pre-loading is set to be 25 in FIG. 6.

If too many windows are allowed to be downloaded at the same time, the process of downloading and viewing web sites may become unduly slow. Hence, using another window cache feature, the maximum number of downloads may be selected by the user, for example, to be 4. The maximum number of downloads indicates the number of preview panes permitted to fetch the contents of web sites simultaneously or concurrently.

Another feature of the preference window 150 is “Enable page content” feature. Using this feature, the user is allowed to restrict the display of the web site contents to certain desired types of contents. By way of example, as it can be seen in FIG. 6, only ‘Images’ are selected for displaying. This way, for example, situations such as two or more web pages trying to play background music at the same time, can be prevented. One or more of the boxes can be checked to allow the display of Pop-ups, Java®, Scripts, Videos, and/or the like. JAVA® is a registered trademark of Sun Microsystems, Inc., Santa Clara, Calif.

FIG. 8 is a flow diagram illustrating a process of loading and displaying web pages in the search result display area 113 in accordance with an exemplary embodiment of the present invention. After a query is submitted to a search engine and the search executed, a number of web pages are preloaded into the windows corresponding to the preview panes 116 (161). The number of pre-loaded web pages may be controlled, for example, using the preference window 150 of FIG. 6. The pre-loaded web pages are displayed (162) in accordance with the matrix format selected by the user, for example.

If the user desires to scroll the search result display area 113 or otherwise change the web pages being displayed on the search result display area 113 (164), the preview panes (or windows) are slid (e.g., re-arranged) (166) such that the panes corresponding to the desired web pages are displayed. Here, if not all the desired web pages have been pre-loaded, additional web pages are loaded into the windows (170). For this, the content presented in one or more preview panes may be updated with new content and the prior content overwritten. The web pages in the windows to be updated may be stored in memory (168) prior to update so that they can be accessed without delay if the user desires to view them in the future. Additional web pages that are not currently displayed, may also be pre-loaded as needed.

Another feature of the exemplary embodiment of the present invention is an ability to create a bookmark that includes multiple search results. Using this feature, bookmarks can be created on the fly and more and more search results can be added as additional searches are performed. The bookmarks, for example, may be built/customized based on the search results. Further, some of the search results can be combined to create one overall bookmark. Using the matrix display feature of the search result display area 113, users can view multiple web pages at the same time.

In another exemplary embodiment of the present invention, each of the windows or frames employed as a preview pane 116 includes a toolbar (e.g., a mini toolbar). In the toolbar, an ‘Expand’ button or symbol may be provided. By pressing or selecting the ‘Expand’ button or symbol, links to other web sites referenced in the web site displayed in the window may be displayed on the left side of the screen (e.g., at the portion of the screen where the search result list area 112 is located) On the right side of the screen (e.g., at the portion of the screen where the search result display area 113 is located), all the linked web sites may be displayed and/or pre-loaded into the windows that are not displayed until corresponding links on the left side of the screen are selected (e.g., highlighted).

In another exemplary embodiment of the present invention, the user may select (via preferences settings, buttons, or other selection device) to have the apparatus use a specified search engine for searches input into the apparatus. The user may also have the apparatus perform a search using two or more different search engines, and display the results in a comparative fashion (for example, side-by-side) so that the user may compare the results generated from one search by multiple search engines.

In another exemplary embodiment according to the present invention, the search apparatus may utilize one or more of the following methods to speed up the display of the search results:

(1) Rather than the search apparatus using a local browser to retrieve web pages based on the URL, the apparatus may include or be coupled to a server component whereby the search engine retrieves the pages for the user and then zips them together (or compresses the pages using any other suitable compression techniques) and sends the files to the apparatus component on the user's machine. The server-side retrieval and compression will speed the overall display process.

(2) The search apparatus may first retrieve the text of the web site and display the retrieved text to the user while loading the images in a secondary fashion.

(3) The search apparatus may load the underlying web page in low resolution (e.g., by displaying every other pixel) for all the results then backfilling pixels in a secondary fashion until a full resolution display is achieved.

(4) The search apparatus may list, and thereby display, the search results in an order based on the load speeds and/or other response/performance measurements of the result web sites. For example, if the search results in 40 results and the apparatus determines that the third result is loading slowly (or is not responding at all), the apparatus would move that result down in the ordered results list provided to the user until the page is retrieved and then it would be reordered to the original rank.

(5) The search apparatus operates with a server component whereby the search engine sends the apparatus component on the user's machine a web site thumbnail or reduced resolution image of the web site which is displayed until the underlying web page at the URL is loaded.

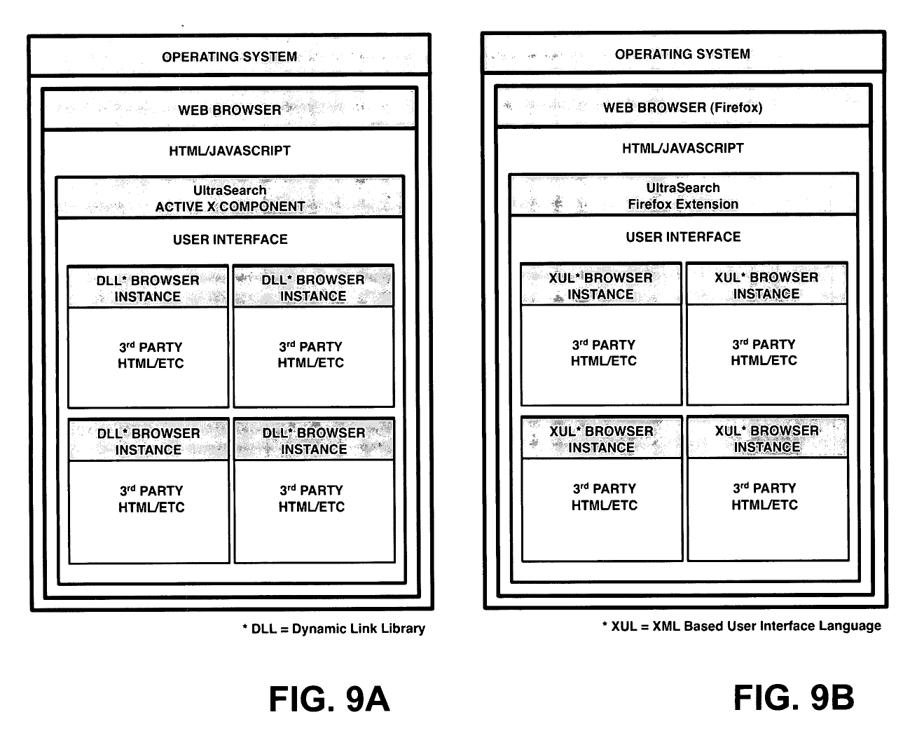

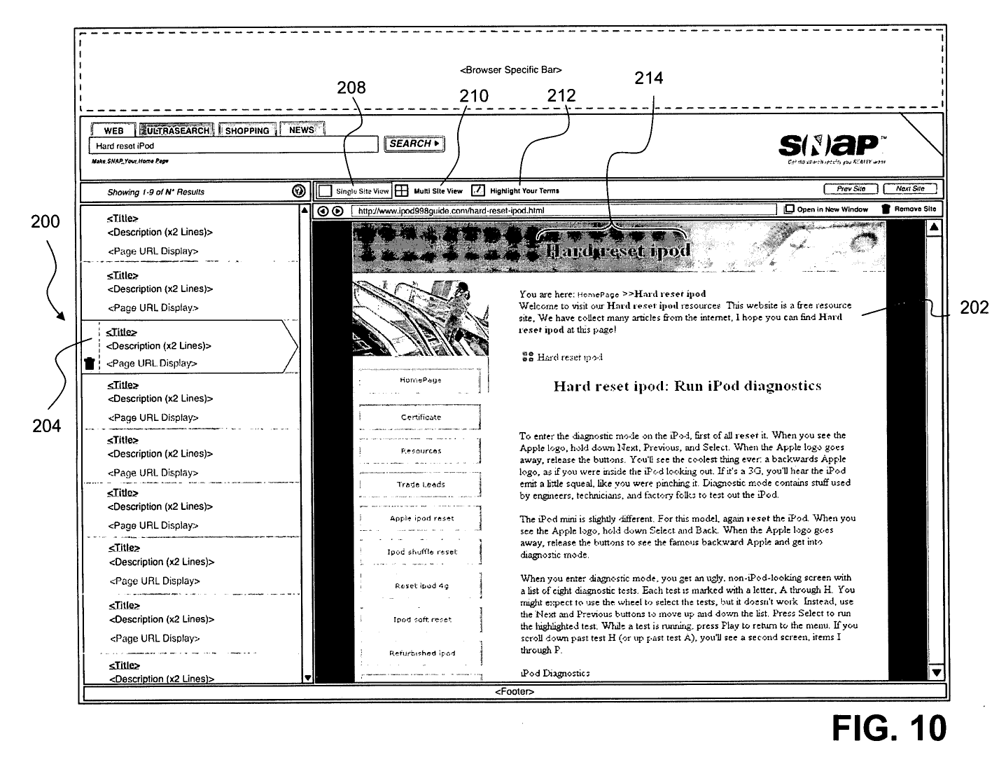

The improved search apparatus providing a search engine interface or search interface in exemplary embodiments of the present invention can be implemented as a stand-alone program or browser plug-in. By way of example, FIG. 9A illustrates a search apparatus implemented as a plug-in into a web browser that runs in an operating system environment. In the example of FIG. 9A, the web browser may be Internet Explorer®. Internet Explorer® is a registered trademark of Microsoft Corporation, Redmond, Wash.

The search apparatus in one exemplary embodiment illustrated in FIG. 9A may be referred to as a selectable search result apparatus with matrix display. When the search apparatus is implemented as a plug-in in the Internet Explorer, the Active X plug-in may need to be downloaded and installed as well. The search apparatus includes a user interface including one or more web browsers that are provided as Dynamic Link Library (DLL) browser instances, one instance for the interface through which the search is conducted and an additional instance for the search result presented in each preview pane. In each of the web browsers, web content is provided for the user to browse and/or select.

Unlike the search apparatus plug-in of FIG. 9A, the search apparatus plug-in of FIG. 9B is implemented in the Firefox web browser. When the search apparatus is implemented as a plug-in in the Firefox web browser, the Firefox Extension may need to be downloaded and installed as well. In the user interface of the search apparatus of FIG. 9B, one or more web browsers may be provided as XML-based User Interface Language (XUL) browser instances. Four browser DLL browser instances shown in both FIGS. 9A and 9B correspond to four preview panes in an exemplary embodiment. While search apparatus plug-ins have been described above in reference to the Internet Explorer and Firefox web browsers, they are not limited thereto, and other search apparatus plug-ins may be implemented in any other suitable web browser without departing from the spirit or scope of the present invention. Of course, search apparatuses in other embodiments may be stand-alone as well.

During conventional searches, when a user types in a query in a conventional search engine, it typically returns multiple pages of results, each abstracted down to a title, a few lines of text and a URL. From that point on, the user is on his or her own. The user must typically scan the pages of results and click on anything that looks related to the search. If the site proves irrelevant to the search, the user has to manually return to the search result page and continue the review of search results again. Even with a broadband Internet connection, this process can be quite tedious.

As either a plug-in or a stand-alone application or computer codes that runs natively in the browser (as a Java script or HTML frames download included with associated content without the need of a separate download from a third-party, for example), the search apparatus in exemplary embodiments of the present invention allows the users to find what they are looking for faster. To this end, the search apparatus does one or more things fundamentally different than other search engines.

Firstly, as described above, the search apparatus of the described embodiments allows a user to preview the web pages linked to (or associated with) the search side-by-side with the list of search results, thereby allowing the user to quickly evaluate the relevancy of the search results without having to leave the list of search results behind. In other words, when the user selects one or more search results using the search apparatus, the search apparatus loads the linked pages side-by-side with the list of search results for the user to preview without having to leave the list of search results.

Secondly, as described above, the search apparatus pre-fetches the pages linked to the search results so that they can be loaded for preview instantly (or very quickly). In combination with the preview capability, this pre-fetching allows the user to evaluate the relevancy of a large number of pages in a short amount of time. Using pre-fetching, the search apparatus according to exemplary embodiments of the present invention pre-loads the pages linked to the search results returned on the search, and in combination with the side-by-side preview feature described above, the search apparatus allows the user to quickly evaluate which pages are most relevant to the search.

In addition, the search apparatus may allow the user to use a mouse and/or up and down arrow keys on the keyboard to quickly browse through the list of pre-loaded search results. By way of example, left/right arrow keys may be used to select the search result list area or the search result display area. The up/down arrow keys may be used to scroll through the search result listings or preview panes in the direction of the key pushed. This way, the user may quickly browse through the search result listing and their linked pages displayed in the preview panes. Additional key functions may be provided in other embodiments.

The search process of the exemplary embodiments also diverges from the conventional search process during a process operation. According to the conventional approach, the user scans, evaluates, chooses and clicks the search results once the system loads the search results. In the process of the described embodiment, however, the user can optionally scan, evaluate and choose search results, but is not required to do so, such that the level of attention and/or decision making required of the user is reduced. Further, the resulting web content can be downloaded automatically (i.e., through the pre-loading feature), so that the user is not required to click a hyperlink of the result to access the associated web content. Also, during the exit operation, the destination page may be loaded automatically without user intervention in the search apparatus in exemplary embodiments according to the present invention.

As can be seen in FIG. 10, the search apparatus includes (1) a search result listing (left frame, i.e., the search result list area) 200 including hyperlinks and summaries of ranked search results; and (2) one or more preview panes or windows depicting at least one of the web pages corresponding to the search results (preferably the right frame, i.e., the search result display area) 202.

In one exemplary embodiment, one web page corresponding to the first one of the search results is presented in the right frame by default. In other embodiments, the first two or more web pages may be displayed in the search result display area 202 by default. As can be seen in FIG. 10, the web page displayed in the search result display area 202 is a complete web page with both text and graphics in the described embodiment. In other embodiments, only a component (e.g., text or graphics) may be displayed in the search result display area 202. The associated search result listing 204, preferably to the left, may be highlighted as can be seen in FIG. 10.

The search apparatus may further include a button adapted to be used to highlight one or more search terms in two or more different colors. Accordingly, in one embodiment, the search apparatus includes a toggle button 212 (i.e., the “Highlight Your Terms” button) that causes search terms in the search result web page to be highlighted in a color different than the background when toggled on by the user. Similarly, two or more unique colors may be used to highlight a plurality of search terms occurring in the web pages presented for preview. As such, the search apparatus can highlight and draw attention to the terms that a user searched for in the previews of the pages linked to the results.

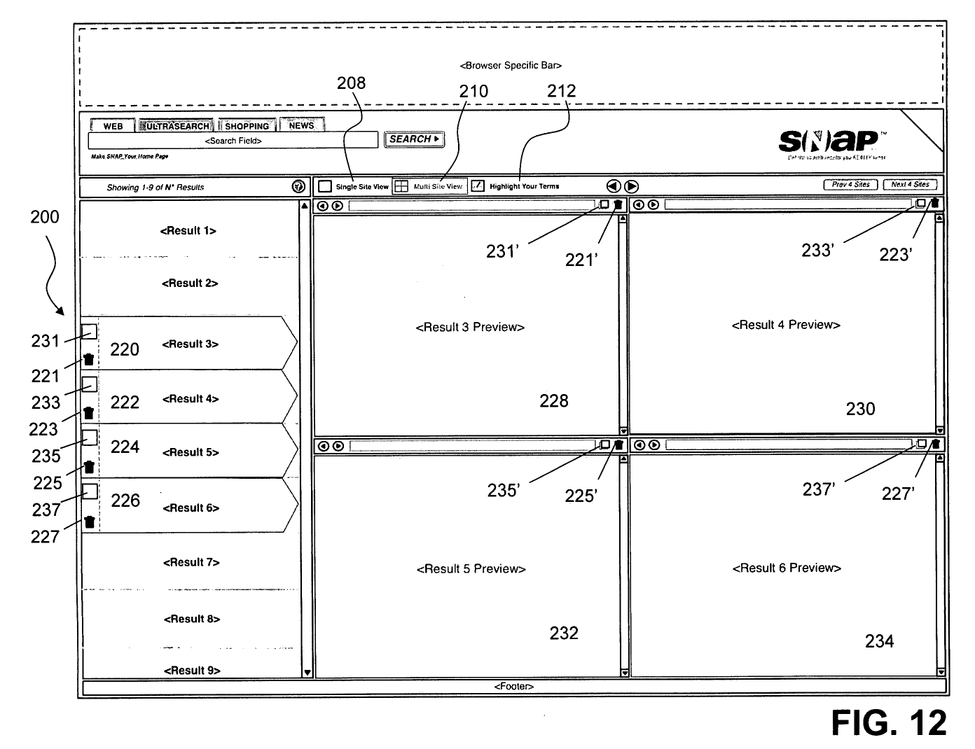

When highlighting is turned on, there is no need to scroll around looking for the search terms because the search terms are made distinct in the preview pages, making it easier to find relevant information. By way of example, as can be seen in FIG. 11, when the toggle button 212 is pressed (or clicked on), the words “Hard”, “reset” and “iPod” 214 that make up the search term or phrase are highlighted in different colors. The highlighting in the described embodiment is achieved by presenting text of a web page against a background color different than web page's designated background color. In other embodiments, various other forms of highlighting including one or more of, but not limited to, colored text, bold text, enlarged text, or underlined text, may be used.

In both FIGS. 10 and 11, it can be seen that a “Single Site View” button 208 has been pressed so that only one preview window pane (or preview pane) is shown on the search result display area 202. This mode may be referred to as a “1×1” preview mode where only one page can be previewed at a time.

As can be seen in FIG. 12, when selected by the user, for example by pressing a “Multi Site View” button 212, the search result display area (i.e., preview window) can be divided into a one or two dimensional matrix of preview panes, each displaying a web page corresponding to a respective one of the search results. As in previously described embodiments, the associated search results 220, 222, 224 and 226 in the search result list area 200 on the left side of the screen are highlighted. This matrix configuration is referred to herein as a “2×2” preview mode since there are four preview panes (i.e., sub-area windows or frames) 228, 230, 232 and 234. These four preview panes 228, 230, 232 and 234 are employed to display web pages <Result 3 Preview>, <Result 4 Preview>, <Result 5 Preview> and <Result 6 Preview>, respectively, which correspond to search results <Result 3>, <Result 4>, <Result 5> and <Result 6> (220, 222, 224, 226), respectively.

It can be seen in FIG. 12 that the four search results 220, 222, 224 and 226 associated with the respective contents displayed in the four preview panes 228, 230, 232 and 234 are highlighted. Further, chevron pointing (i.e., a v-shaped or triangle-shaped pointer shown in FIGS. 10-14B) is used to indicate association between the highlighted search results 220, 222, 224, 226 and the contents of the preview panes 228, 230, 232, 234 at the right side of the search result display area 200. Such chevron/triangle-shaped/v-shaped pointer is used to graphically link the search results in the search result list area to the previews, and may be referred to as a “link indicator” or a “graphic linker”.

Although the search result list area 200 is shown at the left side of the preview panes in FIG. 12, one skilled in the art will appreciate that the search result list area 200 and the preview panes may be displayed in a number of different configurations adjacent to one another, separated from one another, or in different windows, for example. The position and relative placement of the search result list area 200 and preview panes may be defined through user preferences or arranged/rearranged by the user using, for example, an option selected from a pull-down menu or through a click and drag operation in which one or more frames are relocated within the user interface.

In the embodiment illustrated in FIG. 12, the content of the preview panes may be updated without the “sliding window” feature. In other words, the location of each preview pane may be stationary, and the content of each of the preview panes may be updated as the corresponding search result listings in the search result list area 200 are scrolled through, rather than the preview panes being shifted up or down.

Further, using the search apparatus in exemplary embodiments of the present invention, the user can quickly build a list of good results by “checking” or otherwise selecting them, or just as easily, get rid of results that are irrelevant to the search using a tool for “trashing” the irrelevant results.

As shown in FIG. 12, for example, each of the highlighted search results 220, 222, 224, 226 in the search result list area 200 in one embodiment includes an associated check box (i.e., check box icon 231, 233, 235 or 237). Similarly, each of the preview panes 228, 230, 232 and 234 includes an associated check box (231′, 233′, 235′ or 237′). By checking or clicking the check box (in the search result list area or the search result display area) associated with the search result, the search result can be marked for further review by the user. Then the user can view the checked search results without unchecked results, for example, by choosing “View Checked” in a pull-down menu for “View Options” (Not Shown). This feature can be used to remove any unchecked items from view and display a list of search results with only those search results that have been checked by the user.

Further the user may be able to save one or more selected (check box checked) search results and their corresponding previews on the search result display area to a personal collection of search results (residing client side or server side) for review at a later time, thereby providing a user the ability to review those results determined by the user to be the most relevant after the user has trashed or otherwise filtered less relevant results. In addition, the user may be able to print one or more selected (check box checked) results and their corresponding previews. The user may also be able to send one or more selected (check box checked) search results and their corresponding previews by e-mail.

Using the search apparatus illustrated in FIG. 12, the user at any time may also “trash” a search result, which effectively blacklists the search result to prevent it from appearing in the current list of search results, refined search result listings, and/or subsequent search result listings. Hence, trashing a search result will delete it from the results list and load the subsequent result in its place. The trash function can be activated, for example, by pressing (or clicking on) one of the ‘trash can’ icons 221, 223, 225, 227 respectively associated with search results 220, 222, 224 and 226 or one of the ‘trash can’ icons 221′, 223′, 225′ and 227′ respectively associated with the preview panes 228, 230, 232 and 234.

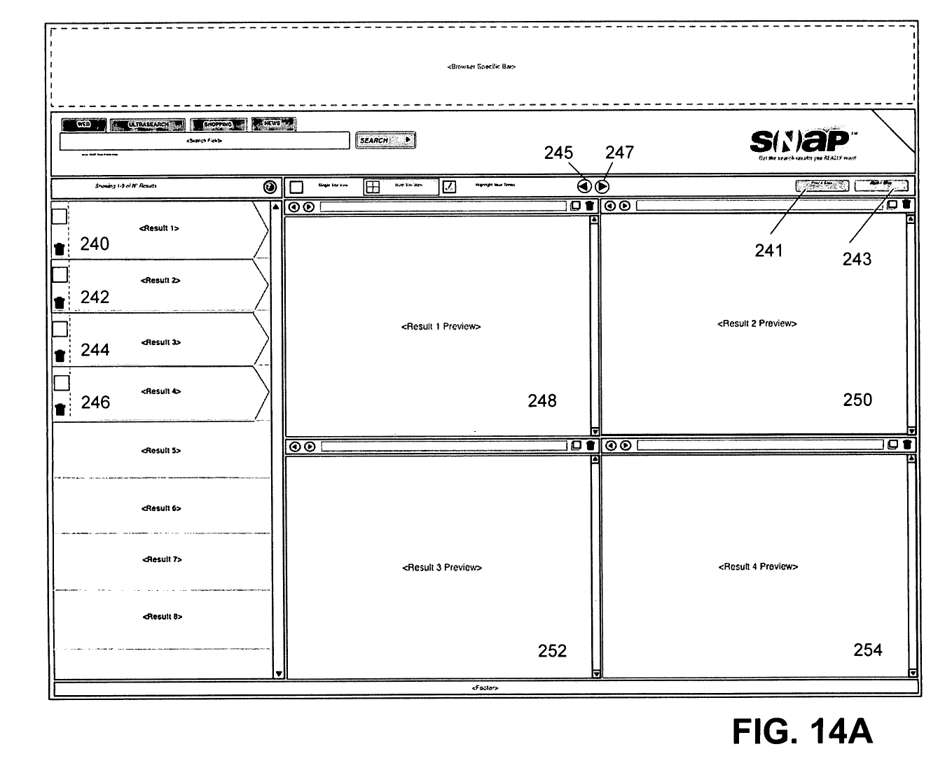

As can be seen in FIG. 13, for example, the search result <Result 5> has been “trashed” so that non-sequential highlighted search results <Result 3>, <Result 4>, <Result 6> and <Result 7> 220, 222, 226, 236 and associated web pages <Result 3 Preview>, <Result 4 Preview>, <Result 6 Preview> and <Result 7 Preview> in preview panes 228, 230, 234, 238 are displayed. Here, the search result <Result 5> 224 of FIG. 12 has been trashed by clicking on the ‘trash can’ icon 225. Now the “trash can” icon 229 and the check box 239 corresponding to the search result <Result 7> are shown on the highlighted search result 236. It can be seen in the search result display area that <Result 7 Preview> is shown in the preview pane 238 that has an associated check box 239′ and an associated ‘trash can’ icon 229′. If the user changes his or her mind after trashing a result, the user may either do the search again or choose “View All” in the pull-down menu for “View Options.” (Not Shown)

The difference between the checking and trashing may be described as a difference between ‘tuning in’ and ‘tuning out’. The checking function allows the user to tune in to only those pages that he or she is interested in. On the other hand, the trashing function allows the user to tune out those pages that he or she is not interested in, leaving the remaining pages which may be of interest to the user. The user may also interactively select or deselect those listings in the search result list area 200 to the left, thereby causing the web pages corresponding to the selected listings to appear in one or more preview panes in the search result display area to the right.

Similar to FIG. 13, the four search results 220, 222, 226 and 236 associated with the respective contents displayed in the four preview panes 228, 230, 234 and 238 are highlighted, and arrow or chevron pointing is used to indicate association between the highlighted search results 220, 222, 226, 236 and the contents of the preview panes 228, 230, 234, 238.

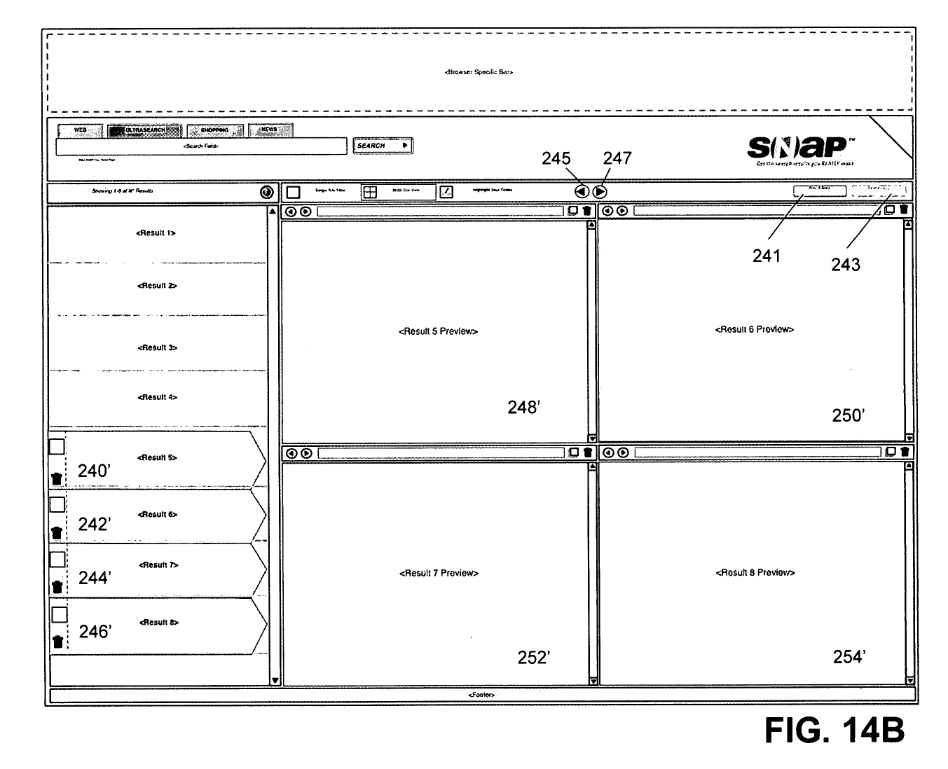

As can be seen in FIGS. 14A and 14B, the user can scroll through the listings which causes the block of one or more highlighted listings to shift up or down within the full listing of search results. For example, it can be seen in FIG. 14A that search results 240, 242, 244 and 246 corresponding to <Result 1>, <Result 2>, <Result 3> and <Result 4> are highlighted, while it can be seen in FIG. 14B that search results 240′, 242′, 244′ and 246′ corresponding to <Result 5>, <Result 6>, <Result 7> and <Result 8> are highlighted. Hence, the search listing in the search result list area has been scrolled by four listings between FIGS. 14A and 14B. Such scrolling forward and backward can be achieved using buttons 241 and 243, for example.

Also, <Result 1 Preview>, <Result 2 Preview>, <Result 3 Preview> and <Result 4 Preview> corresponding to <Result 1>, <Result 2>, <Result 3> and <Result 4>, respectively, are displayed in preview panes 248, 250, 252, 254 in FIG. 14A, while <Result 5 Preview>, <Result 6 Preview>, <Result 7 Preview> and <Result 8 Preview> corresponding to <Result 5>, <Result 6>, <Result 7> and <Result 8>, respectively, are displayed in preview panes 248′, 250′, 252′, 254′ in FIG. 14B.

As can be seen in FIGS. 14A and 14B, the button bar across and immediately above the preview panes 248 and 250 includes forward and back arrow buttons 245, 247 which, when depressed, cause the web pages in the preview panes 248, 250, 252, 254 (or the preview panes 248′, 250′, 252′, 254′) to advance or recede, respectively, by one search result listing. In other embodiments, the user may be able to use the buttons 245, 247 or other similar buttons to drive the preview panes to show the one or more first listings or the one or more last listings in the search result listing area 200, similar to the operation of start-of-page and end-of-page buttons. In such cases, the buttons 245, 247 may alternatively be used to go to the beginning or the end of the list of search results, or the search apparatus may further include additional one or more buttons adapted to be used to go to the beginning or the end of the list of search results.

With the click of a button, the web page associated with a search result may also pop out to a new stand-alone window (e.g., a pop-up window) where it can be viewed full size. As can be seen in FIG. 15, the search apparatus in one exemplary embodiment of the present invention displays highlighted search results <Result 3>, <Result 4>, <Result 6> and <Result 7> 260, 262, 264, 266 and corresponding search result previews (or web pages)<Result 3 Preview>, <Result 4 Preview>, <Result 6 Preview> and <Result 7 Preview> 268, 270, 272, 274. One of the previews 270 is shown as a small preview window 280, and includes “Open in-New Window” button 272. By clicking the “Open in New Window” button 272, the web page of the selected preview window can be opened in a new window (e.g., new web browser window) for an enlarged view. Of course, the other preview panes in the search apparatus may also have respective “Open in New Window” buttons as well.

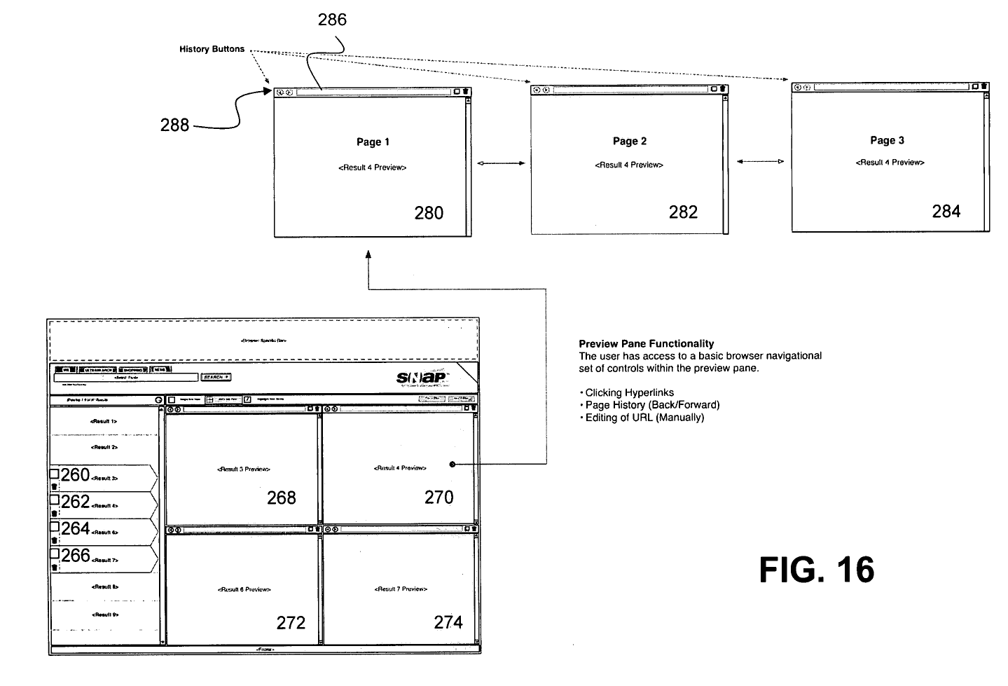

The preview panes 268, 270, 272 and 274 have other functionalities as can be seen in FIG. 16. First, each of the search results <Result 3>, <Result 4>, <Result 6> and <Result 7> 260, 262, 264, 266 can be individually navigated without disturbing the appearance of the web pages associated with search results presented in one or more other preview panes. The history is maintained for each of the preview panes such that by clicking history buttons 288 in each preview pane, the web pages stored in history can be navigated backward and forward chronologically. Further, URL that appears in a URL field 286 for the preview panes, can be edited or new URLs entered to user selectively display different web pages for preview. Using these functionalities, the user has access to a basic browser navigational set of controls within the preview pane. The preview panes are not limited to the functions described herein, and may include other functions and features that would be apparent to those skilled in the art.

In the exemplary embodiments of the present invention disclosed above, the web pages or other resources presented in the preview panes may be displayed in full scale, reduced scale, or enlarged scale. In some embodiments, a screen shot of the web page is uniformly reduced in size according to a predetermined scale before being displayed. In some other embodiments, the search apparatus reduces the web page's graphic information and graphic features at one scale and the text at a different scale. For example, text is generally shrunk less than graphics to preserve the overall appearance of the web page being previewed while keeping the text large enough to be legible. Using this feature, a web page displayed in at least one of the preview panes may be reduced in size, wherein graphics of the web page is reduced more than text of the web page.

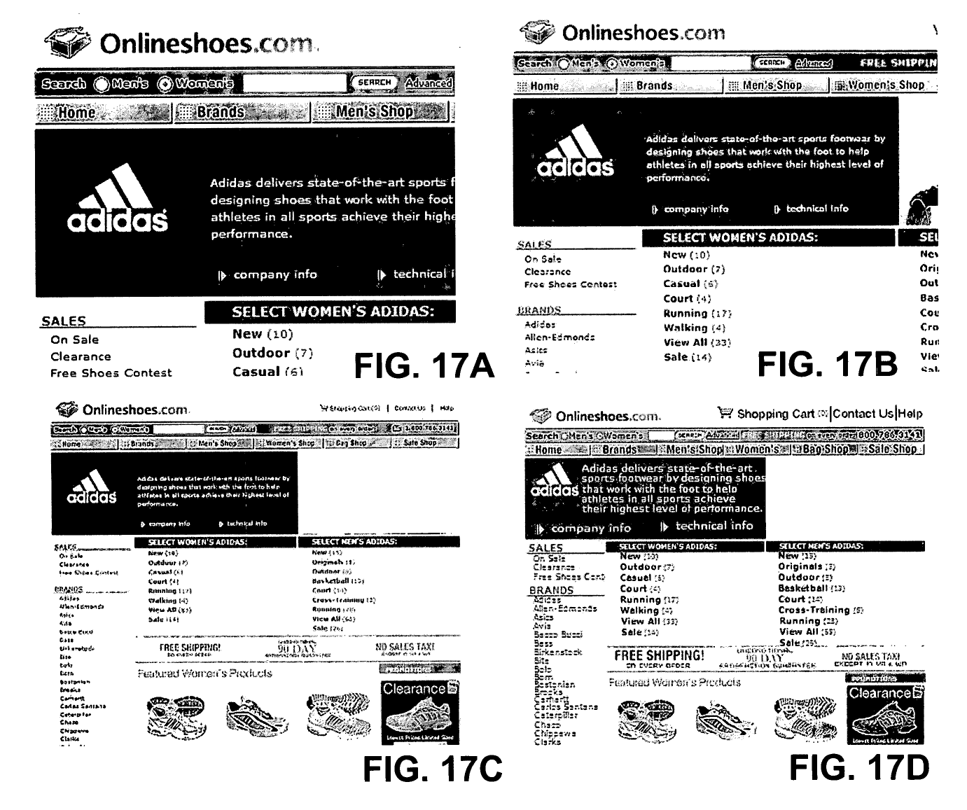

As can be seen in FIG. 17A, when web page is not shrunk (i.e., reduced in size) at all when displayed in a preview pane, an “upper left” problem occurs where only a portion (e.g., upper left portion) of the web page is visible in the preview window pane. When the entire web page including text and graphics is uniformly shrunk a few percent in each dimension, as can be seen in FIG. 17B, more of the web page can be seen at the same time, however, still much of the content of the web page is not visible.

On the other hand, when the web pages are uniformly shrunk many percent in each dimension, the text in the web page becomes illegible. As can be seen in FIG. 17C, the text becomes so small that it cannot be read easily. Hence, in one embodiment of the present invention as can be seen in FIG. 17D, the graphics of the web page may be shrunk or reduced to a size that is substantially smaller than the graphic of the original web pages while the size of the text remains unchanged or is reduced but to a lesser degree than the graphics. As such, the text expands (relative to the graphics) into surrounding white space of the web page graphics that have been reduced in size. This way, the text can be more easily read while fitting the entire web page into a preview pane.

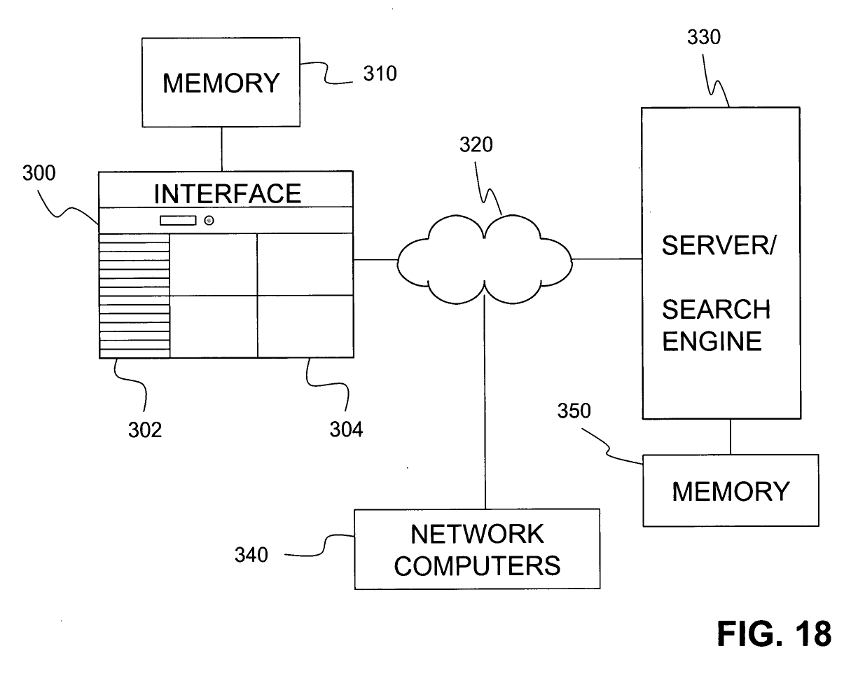

FIG. 18 is a system block diagram illustrating a search apparatus (including an interface 300 and a memory 310) coupled to a server/search engine 330 through a computer network (e.g., Internet) 320 according to one embodiment of the present invention. The server can include a server component of the search apparatus 300 in some embodiments. Those skilled in the art would realize that the server and the search engine can be located separately at multiple different locations. The interface 300 in one embodiment is a stand alone application implemented on a user's computer. In other embodiments, the interface 300 may be implemented as a plug-in, for example, into a corresponding web browser (e.g., as shown in FIGS. 9A and 9B).

The interface 300 includes a search result list area 302 for listing the search results (e.g., corresponding to web sites) found during the search, and a search result display area 304 for displaying the content of one or more web sites corresponding to the search results in sub-areas or preview panes thereof. The memory 310 may include chip memory (e.g., RAM, flash memory, etc.) and/or hard disk drive, and is used to store the search results as well as content of one of more web sites. The web contents stored in the memory 310 may include web sites that are currently displayed in the search result display area 304, web contents that have been pre-loaded into the memory 310 but have not been displayed yet, as well as web contents that had already been displayed but are not currently being displayed.

When a user enters a query (e.g., including search terms or keywords) using the interface 300 (which is typically implemented using a client computer), the query is provided to the engine 330 through the network 320. The engine may include a search engine for obtaining information corresponding to the query over the network 320. The information may be provided, for example, by network computers 340 that are coupled to the network 320. The network computers 340 may include any computers or other devices connected to the network, and may be located at multiple different locations.

A memory 350 coupled to the server/search engine 330 may also include chip memory (e.g., RAM, flash memory, etc.) and/or hard disk drive, and can be used to store search results, web pages or other information relevant to the search, such as a collection of search results to be reviewed by a user at a later time.

As illustrated in FIG. 19 (and FIG. 11 of U.S. provisional patent application No. 60/780,785), some embodiments of the user interface include a search result list area 1002 and a search result display area 1004. The page depicted in the search result list area 1002 in some embodiments includes a number of search result listings (or list of search results) 1006A-1006D. The search results are generally determined/returned by a search engine following a submission of query, and in that sense, may be said to have been predetermined prior to browsing the search results. In particular, the search results visible in the area 1002 are limited to a discrete set typically comprising 10 to 20 results. Additional search results may be viewed via a hyperlink that updates the search result list area 1002 with another predetermined number of search result listings. The user can then view all the available search result listings by navigating through successive lists of results.

In some other embodiments, the search result list area 1002 substantially consists of all the search result listings 1006A-1006D returned by the search engine which are then presented in a single continuous list referred to herein as a bottomless results list. In particular, the search result listings may be populated dynamically such that the bottom of the list of results does not appear until the last result is reached.

While the search results list is presented as a single continuous list, subsets of a total set of search results may be downloaded by the user on an as-needed basis without the entire list of results automatically downloaded. As the user scrolls down the list of results using scroll bar 1008A and/or scroll bar thumb (the movable stub between the arrow buttons) 1008B, for example, the user may hit one or more trigger points embedded in the page that initiate a call to the search engine server through Ajax, for example, to bring in the next set of results without reloading the page. This allows the user to observe a continuous list of results instead of multiple, static pages.

Referring back to FIG. 19, some embodiments of the present invention use a visual indicator to show which result 1006A of the plurality of search results 1006A-1006D listed in the search result list area 1002 is currently being displayed in the preview pane (i.e., search result display area) 1004 to the right. In the exemplary embodiment illustrated in FIG. 19, the indictor includes a bridge or patch 1012 that lies on top of the scroll bar 1008A. The color of the patch 1012 is preferably the same as the background color of the associated search result 1006A, or the same color used to highlight the result 1006A. Such bridge or patch 1012 is used to graphically link the search results in the search result list area to the previews, and may be referred to as a “link indicator” or a “graphic linker” similar to the chevron (or triangular-shaped) pointer in FIGS. 10-14B.

In the exemplary embodiment, the patch 1012 coincides with the individual search result 1006A, even as the result moves up or down in response to the user command that causes the search result listings 1006A-1006D to scroll up or down. If and when the user selects a different search result, the patch is updated to create a bridge between the newly selected result and the associated web page depicted in the preview pane 1004.

While the patch 1012 may lie over the scroll bar 1008A in the described embodiment, the patch 1012 generally lies under the scroll bar thumb 1008B to avoid masking it.

In addition to search results derived by a World Wide Web crawler, the search result listings 1006A-1006D presented in the search result list area 1002 may also display search results acquired from sources other than the Internet. These sources may include local hard drive content, enterprise search data, emails, spreadsheet data, personal databases, and file systems, for example. This feature for listing different types of search results in the same search result list area 1002 may be referred to as a “commingled results” feature.

A set of results in the search result list area 1002 in accordance with the “commingled results” feature could also be from the index of a single search engine, the indexes of a plurality of search engines, the user's hard drive, an RSS feed. The results may include result types such as images, video, news, job listings, personals, classifieds and any combination thereof. Using the “commingled results” feature, the search apparatus can rank all results having same or different result types together and display result types from multiple, distinct databases in the same search result list area.

In some embodiments, the preview pane 1004 is adapted to present a selected portion of the destination URL associated with a search result listing. In particular, the web page is automatically centered in the preview pane 1004 about a portion (either text or image) of the web page that includes the one or more terms present in the user's query. In contrast to conventional search engines in which the upper most portion of the web page or other resource is automatically presented in the preview pane, this embodiment of the present invention reduces or eliminates the need to manually scroll down a web page to locate the relevant text.

Content centering of a web page is based on a two-part process illustrated in FIG. 20. First, a crawler creates a full scroll screen capture of the web page or other resource to be indexed by the search engine. In processes of crawling a distinct URL, a plurality of screen shots are captured: (1) the upper portion of the web page typically presented to the user as well as (2) one or more additional portions of the web page “below-the-fold” area, i.e., the lower portion of the web page normally out of view when the web page is loaded in a convention browser window. The screen shots, referred to herein as captured frames, may be based on any number of digital images standards including BMP, GIF, and JPG, for example.

In the second part of the process, the search engine indexes the text of the captured frames along with information of the position of the text in the captured frames. The position information may be indicated by a vertical and horizontal pixel count relative to the upper left corner of the web page for example. This would render a relational table that can be used to map the occurrence of all text strings on the page to a pixel location. When these two parts of the processes are performed with a search engine, a lookup is performed to find the pixel location of the user's term. This way, the associated web page content is displayed as centered (and/or otherwise highlighted) about the term.

The two parts of the process associated with content centering are illustrated in FIG. 20. A web page 2000 or other resource is retrieved by a crawler, for example. A first frame 2002A is used to capture the upper-most portion of the web page 2000. The first frame 2002A includes the text and/or graphics corresponding to the portion of the web page 2000 that would be visible to the typical viewer when downloading or previewing the web page. Additional frames 2002B, 2002C may be used to capture the portions of the web page 2000 that are below-the-fold and therefore typically visible to the user only after scrolling down. Thereafter, these captured frames 2002A-2002C may be digitally stitched together to form a single seamless facsimile or replica 2002 of the original web page 2000 available for storage and retrieval.

Next, the search engine records the position of text and graphics present in the replica 2002. The position of a word 2004, for example, may be given in terms of the number of pixels below the upper-most edge and to the right of the left-most edge of the replica 2002. The text/graphics and associated information are retained in a relational database referred to herein as a searchable index 2006. The associated information generally includes, at the very least, the replica 2002 or individual captured frames 2002A-2002C, the position information of the text/graphics, and the URL of the web page from which the text was retrieved.

When a subsequent user (or the same user) enters a query to search for the text and graphics, the search engine retrieves the replica 2002 from the index 2006 and present the image in the preview pane. In accordance with some embodiments of the present invention, the portion of the replica 2002 presented in the preview pane includes the text or graphics of interest to the user, even if this information lies below-the-fold. In particular, the search engine uses the position information associated with the text/graphics to display a segment of the replica 2002 starting above and ending below the query term, thereby saving the user the effort of scrolling down the web page 2000 to manually locate the relevant information.

If the user searches the character string “RPQ” 2004 present in the replica 2002 at the intersection of the vertical and horizontal lines, the search engine retrieves the associated replica 2002 from index 2006 and displays the portion 2014 of the replica that includes the string “RPQ” (at position 2012). Using the URL associated with the original web page 2000, the user may select a button in the user interface to bring up the web page in a new window.

The preview pane may include live destination html, proxied destination html, flash destination rendering, java destination rendering, destination site screen captures, live destination image rendering, RSS feeds, text abstracts, PDF, Microsoft Office documents, editorial content, and third-party content, for example.

Referring back to FIG. 19, in exemplary embodiments according to the present invention, web pages associated with search results may be previewed in the preview pane (or search result display area) 1004. Some sites, however, attempt to protect their brand by blocking the ability to load that site inside of another site such as the search engine's preview pane 1004. Other sites may launch malicious software or virus upon a users' entry. These two cases are demonstrative of the types of environments a search engine would like to avoid, but there may be other instances where a user may desire to avoid one or more web sites.

The search engine in one exemplary embodiment may avoid these scenarios by creating lists of sites, namely a black list, a gray list, and in some cases a white list. A harmful site that may attempt to download viruses onto the users' computer or read data from the users' computer is placed on a ‘black’ list so that it is completely blocked from being displayed to the end user. If a website is a harmless site but attempts to break out of a frame like preview pane 1004, the URL is assigned to a ‘gray’ list. When sites associated with the gray list are displayed in the preview pane 1004, certain functionality supported by the site is suppressed to prevent breakouts while still displaying the valid content. A ‘white’ list is for known sites that do not breakout or otherwise alter a generic web experience. A ‘no’ list would be a default setting for all other sites that do not belong to white, black or grey until they are crawled, indexed and marked as such.

The code base for this feature and/or other features of the exemplary embodiments may include, but is not limited to, ActiveX, DHTML, Ajax, JavaScript, Java, Flash, and other suitable technologies not invented yet.

While certain exemplary embodiments have been described above in detail and shown in the accompanying drawings, it is to be understood that such embodiments are merely illustrative of and not restrictive of the broad invention. It will thus be recognized that various modifications may be made to the illustrated and other embodiments of the invention described above, without departing from the spirit or scope of the present invention, which are to be determined by the appended claims and their equivalents.

We claim:

1. A search apparatus comprising:
a search term field adapted to receive a search term to be submitted to a search engine to initiate a search;
a search result list area for displaying a list of search results identified by the search engine; and
a search result display area for displaying one or more web pages corresponding to the search results, wherein the web pages are displayed in a matrix format when at least two of the web pages are concurrently displayed, and
wherein a number of the web pages concurrently displayed in the search result display area is user selectable.

2. The search apparatus of claim 1, wherein the search results in the search result list area that correspond to the displayed web pages are highlighted.

3. The search apparatus of claim 1, wherein the web pages are displayed in corresponding windows among a plurality of windows.

4. The search apparatus of claim 3, wherein the plurality of windows include windows that are not currently displayed in addition to the windows corresponding to currently displayed web pages.

5. The search apparatus of claim 4, wherein the windows that are not currently displayed are pre-loaded with web pages corresponding to the search results that are before or after the search results corresponding to the currently displayed web pages.

6. The search apparatus of claim 3, wherein the windows are pre-loaded, and are dynamically updated such that the pre-loaded windows contain substantially the same number of web pages that are before and after the web pages being displayed.

7. The search apparatus of claim 3, wherein the web pages in the windows are stored in memory prior to recycling the windows such that they do not have to be downloaded again over the Internet.

8. The search apparatus of claim 3, wherein the windows including the displayed web pages are re-arranged in the search result display area such that the web pages need not be loaded again each time the web pages displayed in the search result display area are updated.

9. The search apparatus of claim 3, wherein at least one of a maximum number of the windows that are pre-loaded or a maximum number of the windows that are downloaded concurrently is user selectable.

10. The search apparatus of claim 3, wherein at least one of the search result display area or at least one of the windows is adapted to be zoomed in and out.

11. The search apparatus of claim 3, wherein at least one of the plurality of windows in the search result display area includes a URL field adapted for a user to enter and edit a URL therein.

12. The search apparatus of claim 3, wherein at least one of the plurality of windows in the search result display area includes history buttons adapted for a user to navigate backward and forward through different web pages stored in history of the respective windows.

13. The search apparatus of claim 3, wherein at least one of the plurality of windows in the search result display area includes a button adapted to be clicked by a user, thereby enabling the user to display a web page in the window in a new web browser window.

14. The search apparatus of claim 3, wherein a web page displayed in at least one of the plurality of windows is reduced in size, wherein graphics of the web page is reduced more than text of the web page.

15. The search apparatus of claim 3, wherein at least one of the search results in the search result list area and/or at least one window in the search result display area has an associated icon adapted to be used to remove the associated search result from the list of search results.

16. The search apparatus of claim 3, wherein at least one of the search results in the search result list area and/or at least one window in the search result display area has an associated icon adapted to be used to select the associated search result for a further review.

17. The search apparatus of claim 3, wherein the web page displayed in at least one of the windows is displayed with the search term located at or near the center of the window.

18. The search apparatus of claim 1, wherein the search apparatus is adapted to provide a bookmark corresponding to multiple search results.

19. The search apparatus of claim 1, wherein the search apparatus is capable of displaying a list of links found in a particular web site on one side of the screen, together with their respective contents on the other side of the screen.

20. The search apparatus of claim 1, further comprising a button adapted to be used to display the search term appearing in the web pages differently.

21. The search apparatus of claim 1, further comprising one or more buttons adapted to be used to navigate to beginning or end of the search results.

22. The search apparatus of claim 1, wherein the search results are displayed as a one continuous list of search results regardless of a number of the search results found during a search.

23. The search apparatus of claim 1, further comprising a bridge linking one of the search results to a corresponding one of the web pages displayed in the search result display area.

24. The search apparatus of claim 23, wherein a location of the bridge is adjusted as different one of the web pages is displayed in the search result display area, such that the bridge links the displayed web page to the corresponding one of the search results.

25. The search apparatus of claim 1, wherein the search results include search results acquired from sources other than the Internet.

26. The search apparatus of claim 1, wherein the search engine creates a list of sites according to whether the sites are harmless or harmful.

27. A search apparatus including a web browser and a plug-in adapted to be implemented into the web browser, the search apparatus comprising:
a search term field adapted to receive a search term to be submitted to a search engine to initiate a search;
a search result list area for displaying a list of search results found during the search; and
a search result display area for displaying one or more web pages corresponding to the search results, wherein the web pages are displayed in a matrix format when at least two of the web pages are concurrently displayed, and
wherein a number of the web pages concurrently displayed in the search result display area is user selectable.

28. The search apparatus of claim 27, wherein the web browser is Internet Explorer, Netscape Navigator or Firefox web browser.

29. A method of displaying a list of search results concurrently with one or more web pages corresponding to the search results, the method comprising:
submitting a search term to a search engine to initiate a search;
displaying the list of search results in a first area of a display screen; and
displaying said one or more web pages corresponding to the search results in a second area of the display screen, wherein the web pages are displayed in a matrix format when at least two of the web pages are concurrently displayed, and
wherein a number of the web pages concurrently displayed in the second area is user selectable.

30. The method of claim 29, wherein the web pages are displayed in corresponding windows among a plurality of windows, the method further comprising centering at last one of the web pages about the search term in the corresponding window.

31. The method of claim 30, wherein said centering comprises:
storing one or more portions of said at least one of the web pages including a portion that is normally out of view when the web page is initially loaded;
indexing text in said one or more portions to map the text in said at least one of the web pages to a pixel location; and
looking up the pixel location of the search term to display the at least one of the web pages centered about the search term.
